(19) United States
(12) Patent Application Publication
(10) Pub. No.: US 2026/0012640 A1
(43) Pub. Date: Jan. 8, 2026

(54) INTER-PREDICTION FOR POINT CLOUD COMPRESSION

(71) Applicant: QUALCOMM Incorporated, San Diego, CA (US)

(72) Inventors: Adarsh Krishnan Ramasubramonian, Irvine, CA (US); Geert Van der Auwera, San Diego, CA (US); Anique Akhtar, San Diego, CA (US); Reetu Hooda, San Diego, CA (US); Marta Karczewicz, San Diego, CA (US)

(21) Appl. No.: 19/259,893

(22) Filed: Jul. 3, 2025

Related U.S. Application Data
(60) Provisional application No. 63/668,708, filed on Jul. 8, 2024.
(60) Provisional application No. 63/669,593, filed on Jul. 10, 2024.
(60) Provisional application No. 63/672,032, filed on Jul. 16, 2024.

(51) Int. Cl. H04N 19/597; H04N 19/172; H04N 19/503; H04N 19/70

(52) U.S. Cl. CPC H04N 19/597; H04N 19/172; H04N 19/503; H04N 19/70

(57) ABSTRACT

A method of decoding point cloud data includes applying a scale and offset to a reference frame in a single stage to generate an updated reference frame; and decoding the point cloud data of a current frame based on the updated reference frame.

This application claims the benefit of U.S. Provisional Patent Application 63/668,708, filed 8 Jul. 2024, U.S. Provisional Patent Application 63/669,593, filed 10 Jul. 2024, and U.S. Provisional Patent Application 63/672,032, filed 16 Jul. 2024, the entire content of each is incorporated herein by reference.

### TECHNICAL FIELD

This disclosure relates to point cloud encoding and decoding.

### BACKGROUND

A point cloud is a collection of points in a 3-dimensional space. The points may correspond to points on objects within the 3-dimensional space. Thus, a point cloud may be used to represent the physical content of the 3-dimensional space. Point clouds may have utility in a wide variety of situations. For example, point clouds may be used in the context of autonomous vehicles for representing the positions of objects on a roadway. In another example, point clouds may be used in the context of representing the physical content of an environment for purposes of positioning virtual objects in an augmented reality (AR) or mixed reality (MR) application. Point cloud compression is a process for encoding and decoding point clouds. Encoding point clouds may reduce the amount of data required for storage and transmission of point clouds.

### SUMMARY

In general, this disclosure describes techniques for generating prediction samples for coding (e.g., encoding or decoding) a current frame of point cloud data (e.g., improvements to inter-prediction for predictive geometry coding of point clouds). In one or more examples, an encoder or a decoder may apply a spherical coordinate conversion scale and offset to a reference frame in a single stage. In one or more examples, an encoder or a decoder may perform offset adjustment in examples when attributes are coded using a predicting transform or a lifting transform. The example techniques may reduce memory utilization because intermediate values may not need to be stored in a single stage process, and may reduce processing time because the techniques may be performed in a single stage process.

In one example, the disclosure describes a method of decoding point cloud data, the method comprising: applying a scale and offset to a reference frame in a single stage to generate an updated reference frame; and decoding the point cloud data of a current frame based on the updated reference frame.

In one example, the disclosure describes a device for decoding point cloud data, the device comprising: one or more memories configured to store point cloud data for a current frame and point cloud data for a reference frame; and processing circuitry coupled to the one or more memories and configured to: apply a scale and offset to the reference frame in a single stage to generate an updated reference frame; and decode the point cloud data of the current frame based on the updated reference frame.

In one example, the disclosure describes a device for encoding point cloud data, the device comprising: one or more memories configured to store point cloud data for a current frame and point cloud data for a reference frame; and processing circuitry coupled to the one or more memories and configured to: apply a scale and offset to the reference frame in a single stage to generate an updated reference frame; and encode the point cloud data of the current frame based on the updated reference frame.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example encoding and decoding system that may perform the techniques of this disclosure.

FIG. 2 is a block diagram illustrating an example Geometry Point Cloud Compression (G-PCC) encoder.

FIG. 3 is a block diagram illustrating an example G-PCC decoder.

FIG. 4 is a conceptual diagram illustrating an example of octree split for geometry coding.

FIG. 5 is a conceptual diagram illustrating an example of a prediction tree.

FIGS. 6A and 6B are conceptual diagrams illustrating an example of a spinning LIDAR acquisition model.

FIG. 7 is a conceptual diagram illustrating an example of inter-prediction of a current point (curPoint) from a point (interPredPt) in a reference frame.

FIG. 8 is a block diagram illustrating an example geometry encoding unit of FIG. 2 in more detail.

FIG. 9 is a block diagram illustrating an example attribute encoding unit of FIG. 2 in more detail.

FIG. 10 is a block diagram illustrating an example geometry decoding unit of FIG. 3 in more detail.

FIG. 11 is a block diagram illustrating an example attribute decoding unit of FIG. 3 in more detail.

FIG. 12 is a flow diagram illustrating an example of decoding point cloud data.

FIG. 13 is a conceptual diagram illustrating an example of identifying an additional inter predictor point obtained from a first point that has azimuth greater than the inter prediction point.

FIG. 14 is a flow diagram illustrating an example of generating a compensated reference frame from a reference frame.

FIG. 15 is a conceptual diagram illustrating an example of azimuth resampling of motion compensated reference.

FIG. 16 is a flow diagram illustrating an example of spherical coordinate conversion.

FIG. 17 is a flow diagram illustrating example of values for geometry and attribute prediction.

FIG. 18 is a flow diagram illustrating an example of generating a spherical table for inter-prediction.

FIG. 19 is a conceptual diagram illustrating an example of a spherical table with only one point per entry.

FIG. 20 is a conceptual diagram illustrating an example of a spherical table with multiple (maximum K) points per entry.

FIG. 21 is a flow diagram illustrating an example of two stages for applying scale and offset to a reference frame.

FIG. 22 is a flow diagram illustrating an example of a single stage for applying scale and offset to a reference frame.

FIG. 23 is a flow diagram illustrating an example syntax element structure associated with enabling inter prediction (including bi-prediction) for geometry and attributes.

FIG. 24 is a flow diagram illustrating another example syntax element structure associated with enabling inter prediction (including bi-prediction) for geometry and attributes.

FIG. 25 is a flowchart illustrating an example method of operation.

FIG. 26 is another flowchart illustrating an example method of operation.

FIG. 27 is a conceptual diagram illustrating an example range-finding system that may be used with one or more techniques of this disclosure.

FIG. 28 is a conceptual diagram illustrating an example vehicle-based scenario in which one or more techniques of this disclosure may be used.

FIG. 29 is a conceptual diagram illustrating an example extended reality system in which one or more techniques of this disclosure may be used.

FIG. 30 is a conceptual diagram illustrating an example mobile device system in which one or more techniques of this disclosure may be used.

### DETAILED DESCRIPTION

In Geometry Point Cloud Compression (G-PCC), geometry data (e.g., coordinate information) and attribute data (e.g., color, reflectance, opacity, etc.) may be encoded and decoded separately. One example way of encoding and decoding attribute data is using inter-prediction. In inter-prediction, attribute data of a current point a current frame of point cloud data is encoded or decoded based on attribute data of a point (e.g., reference point) in another frame (e.g., reference frame) of point cloud data. For instance, the attribute data of the reference point may be a predictor for the attribute data of the current point. A G-PCC encoder may determine residual information indicative of a difference between attribute data of the reference point in the current frame and attribute data of points in the updated reference frame, and signal the residual information. A G-PCC decoder may determine the reference point using the same techniques as the G-PCC encoder, and may add the residual information to the attribute data of the reference point to reconstruct the current point. The G-PCC encoder and G-PCC decoder may repeat these steps. That is, the G-PCC encoder may signal and the G-PCC decoder may receive residual information indicative of a difference between attribute data of points in the current frame and attribute data of points in the updated reference frame. The G-PCC decoder may reconstruct the attribute data of the current frame based on the residual information.

Although the attribute data is being inter-predicted, the coordinate data of the reference point may be needed for identifying the reference point. However, rather than using the coordinate data used for encoding or decoding the geometry data (e.g., the actual coordinates), there may be coding gains from offsetting and scaling the coordinates of points in the reference frame to generate an updated reference frame having points associated with the updated coordinates (e.g., the offset and scaled coordinates).

This disclosure describes example techniques to generate the updated reference frame in a single stage. For instance, the G-PCC encoder and the G-PCC decoder may determine an offset and apply that offset to the reference frame to directly generate the updated reference frame. For instance, in some techniques, the G-PCC encoder and the G-PCC decoder may generate a first offset based on the coordinates of samples in the reference frame and apply that first offset to samples in the reference frame to generate an intermediate reference frame. Then, the G-PCC encoder and the G-PCC decoder may determine a second offset based on the first offset and based on coordinates of samples in the current frame. The G-PCC encoder and G-PCC decoder may then apply the second offset to the intermediate reference frame to generate the update reference frame that is used for attribute data encoding or decoding.

Techniques where the intermediate reference frame is generated may be considered as a multiple stage reference frame generation technique. In the example techniques described in this disclosure, the G-PCC encoder and the G-PCC decoder may generate the updated reference frame in a single stage. The term “single stage” as used in this disclosure refers to a direct generation of the updated reference frame from the reference frame, without generation of sample values for an intermediate reference frame.

Applying a scale and offset to a reference frame in a single stage to generate an updated reference frame may provide benefits over applying a scale and offset to a reference frame in a multi-stage technique. For instance, there may be fewer data to store in the single stage technique, which promotes memory utilization, and performing operations in a single stage may reduce latency compared to multi-stage techniques. Therefore, the example techniques described in this disclosure may integrate techniques related to generating an updated reference frame into an application that improves the overall functionality of G-PCC encoder and G-PCC decoder, and generally improves the technology of point cloud compression.

For ease of description, the example techniques are described with respect to spherical coordinates which include a radius coordinate (rad), an azimuth coordinate (phi), and a laser identification coordinate (laserID). However, the example techniques should not be considered limited.

To apply the scale and offset to the reference frame in the single stage, the G-PCC encoder or G-PCC decoder may be configured to determine respective spherical coordinate minimum values in the reference frame. For example, the G-PCC encoder and the G-PCC decoder may determine a first radius minimum value that is a minimum among radius coordinates of the points in the reference frame, determine a first azimuth minimum value that is a minimum among azimuth coordinates of the points in the reference frame, and determine a first laser identification minimum value that is a minimum among laser identification coordinates of the points in the reference frame.

In one or more example, the first radius minimum value, the first azimuth minimum value, and the first laser identification minimum value may all be from different points in the reference frame, or two or more may be from different points, but possible for all three to come from the same point. That is, the first radius minimum value, the first azimuth minimum value, and the first laser identification minimum value are all respective spherical coordinate minimum values from all respective spherical coordinates of points in the reference frame.

The G-PCC encoder and G-PCC decoder may determine respective spherical coordinate minimum values in the current frame. For example, the G-PCC encoder and the G-PCC decoder may determine a second radius minimum value that is a minimum among radius coordinates of points in the current frame, determine a second azimuth minimum value that is a minimum among azimuth coordinates of the points in the current frame, and determine a second laser identification minimum value that is a minimum among laser identification coordinates of the points in the current frame.

Similar to above, in one or more example, the second radius minimum value, the second azimuth minimum value, and the second laser identification minimum value may all be from different points in the current frame, or two or more may be from different points, but possible for all three to come from the same point. That is, the second radius minimum value, the second azimuth minimum value, and the second laser identification minimum value are all respective spherical coordinate minimum values from all respective spherical coordinates of points in the current frame.

Also, because the example techniques may be related to encoding and decoding of attribute data for the current frame, from the perspective of the G-PCC decoder, the spherical coordinates for the points in the current frame may be available as part of the decoding of the geometry data. That is, the encoding and decoding of the geometry data may be separate from the encoding or decoding of the geometry data, and from the perspective of the G-PCC decoder, the decoding of the geometry data may be before the decoding of the attribute data, and hence, the coordinates for the current frame are available for decoding the attribute data of the current frame.

The G-PCC encoder and the G-PCC decoder may determine respective spherical coordinate offsets based on the respective spherical coordinate minimum values in the reference frame and the respective spherical coordinate minimum values in the current frame. For example, the G-PCC encoder and the G-PCC decoder may determine a radius offset based on a minimum between the first radius minimum value and the second radius minimum value, determine an azimuth offset based on a minimum between the first azimuth minimum value and the second azimuth minimum value, and determining a laser identification offset based on a minimum between the first laser identification minimum value and the second laser identification minimum value.

The G-PCC encoder and the G-PCC decoder may apply the respective spherical coordinate offsets to respective spherical coordinates of points in the reference frame. For example, the G-PCC encoder and the G-PCC decoder may for each point in the reference frame, subtract the radius offset from a radius coordinate of a respective point in the reference frame to generate a radius offset value for the respective point, subtract the azimuth offset from an azimuth coordinate of the respective point in the reference frame to generate an azimuth offset value for the respective point, and subtract the laser identification offset from a laser identification coordinate of a respective point in the reference frame to generate a laser identification offset value for the respective point.

The G-PCC encoder and the G-PCC decoder may scale, with respective scale factors, the result of applying the respective spherical coordinate offsets to the respective spherical coordinates of points in the reference frame to generate the updated reference frame. For example, the G-PCC encoder and the G-PCC decoder may scale, with a first scale factor, the radius offset value for the respective point to generate a radius coordinate for an updated point in the updated reference frame, scale, with a second scale factor, the azimuth offset value for the respective point to generate an azimuth coordinate for the updated point in the updated reference frame, and scale, with a third scale factor, the laser identification offset value for the respective point to generate a laser identification coordinate for the updated point in the updated reference frame.

The G-PCC encoder may encode the current frame using the updated reference frame. For instance, the G-PCC encoder may determine residual information indicative of a difference between attribute data of points in the current frame and attribute data of points in the updated reference frame and signal the residual information. The G-PCC decoder may receive residual information indicative of a difference between attribute data of points in the current frame and attribute data of points in the updated reference frame and reconstruct the attribute data of the current frame based on the residual information.

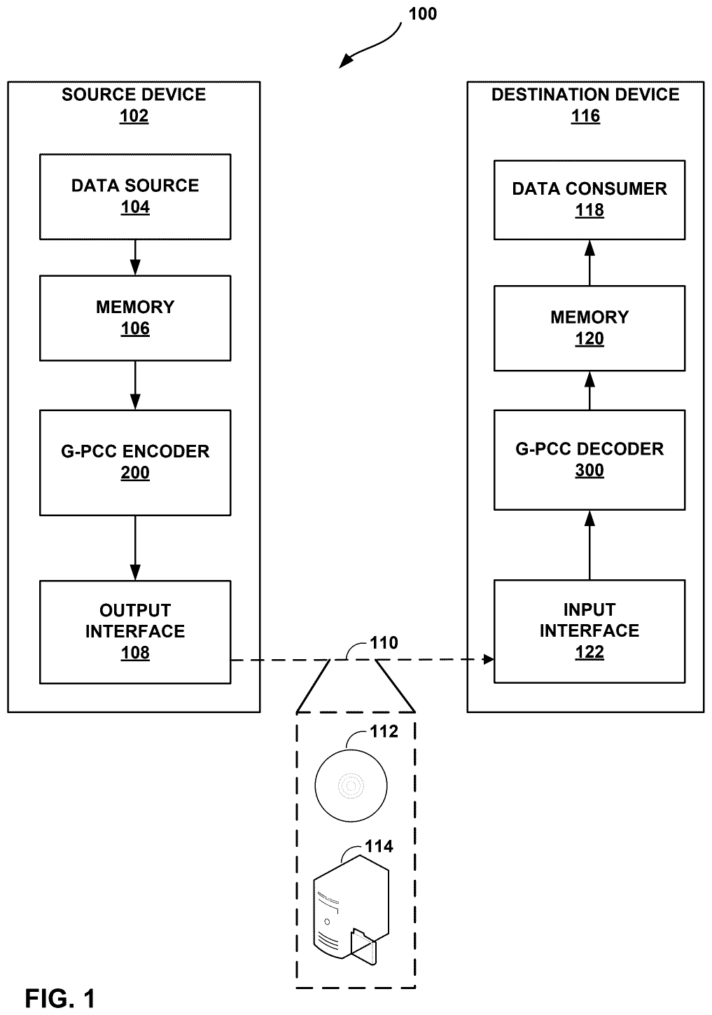

FIG. 1 is a block diagram illustrating an example encoding and decoding system 100 that may perform the techniques of this disclosure. The techniques of this disclosure are generally directed to coding (encoding and/or decoding) point cloud data, i.e., to support point cloud compression. In general, point cloud data includes any data for processing a point cloud. The coding may be effective in compressing and/or decompressing point cloud data.

As shown in FIG. 1, system 100 includes a source device 102 and a destination device 116. Source device 102 provides encoded point cloud data to be decoded by a destination device 116. Particularly, in the example of FIG. 1, source device 102 provides the point cloud data to destination device 116 via a computer-readable medium 110. Source device 102 and destination device 116 may comprise any of a wide range of devices, including desktop computers, notebook (i.e., laptop) computers, tablet computers, set-top boxes, telephone handsets such as smartphones, televisions, cameras, display devices, digital media players, video gaming consoles, video streaming devices, terrestrial or marine vehicles, spacecraft, aircraft, robots, LIDAR devices, satellites, or the like. In some cases, source device 102 and destination device 116 may be equipped for wireless communication.

In the example of FIG. 1, source device 102 includes a data source 104, a memory 106, a G-PCC encoder 200, and an output interface 108. Destination device 116 includes an input interface 122, a G-PCC decoder 300, a memory 120, and a data consumer 118. In accordance with this disclosure, G-PCC encoder 200 of source device 102 and G-PCC decoder 300 of destination device 116 may be configured to apply the techniques of this disclosure related to coding of point cloud data. Thus, source device 102 represents an example of an encoding device, while destination device 116 represents an example of a decoding device. In other examples, source device 102 and destination device 116 may include other components or arrangements. For example, source device 102 may receive data (e.g., point cloud data) from an internal or external source. Likewise, destination device 116 may interface with an external data consumer, rather than include a data consumer in the same device.

System 100 as shown in FIG. 1 is merely one example. In general, other digital encoding and/or decoding devices may perform the techniques of this disclosure related to coding of point cloud data. Source device 102 and destination device 116 are merely examples of such devices in which source device 102 generates coded data for transmission to destination device 116. This disclosure refers to a “coding” device as a device that performs coding (encoding and/or decoding) of data. Thus, G-PCC encoder 200 and G-PCC decoder 300 represent examples of coding devices, in particular, an encoder and a decoder, respectively. In some examples, source device 102 and destination device 116 may operate in a substantially symmetrical manner such that each of source device 102 and destination device 116 includes encoding and decoding components. Hence, system 100 may support one-way or two-way transmission between source device 102 and destination device 116, e.g., for streaming, playback, broadcasting, telephony, navigation, and other applications.

In general, data source 104 represents a source of data (i.e., raw, unencoded point cloud data) and may provide a sequential series of “frames”) of the data to G-PCC encoder 200, which encodes data for the frames. Data source 104 of source device 102 may include a point cloud capture device, such as any of a variety of cameras or sensors, e.g., a 3D scanner or a light detection and ranging (LIDAR) device, one or more video cameras, an archive containing previously captured data, and/or a data feed interface to receive data from a data content provider. Alternatively or additionally, point cloud data may be computer-generated from scanner, camera, sensor or other data. For example, data source 104 may generate computer graphics-based data as the source data, or produce a combination of live data, archived data, and computer-generated data. In each case, G-PCC encoder 200 encodes the captured, pre-captured, or computer-generated data. G-PCC encoder 200 may rearrange the frames from the received order (sometimes referred to as “display order”) into a coding order for coding. G-PCC encoder 200 may generate one or more bitstreams including encoded data. Source device 102 may then output the encoded data via output interface 108 onto computer-readable medium 110 for reception and/or retrieval by, e.g., input interface 122 of destination device 116.

Memory 106 of source device 102 and memory 120 of destination device 116 may represent general purpose memories. In some examples, memory 106 and memory 120 may store raw data, e.g., raw data from data source 104 and raw, decoded data from G-PCC decoder 300. Additionally or alternatively, memory 106 and memory 120 may store software instructions executable by, e.g., G-PCC encoder 200 and G-PCC decoder 300, respectively. Although memory 106 and memory 120 are shown separately from G-PCC encoder 200 and G-PCC decoder 300 in this example, it should be understood that G-PCC encoder 200 and G-PCC decoder 300 may also include internal memories for functionally similar or equivalent purposes. Furthermore, memory 106 and memory 120 may store encoded data, e.g., output from G-PCC encoder 200 and input to G-PCC decoder 300. In some examples, portions of memory 106 and memory 120 may be allocated as one or more buffers, e.g., to store raw, decoded, and/or encoded data. For instance, memory 106 and memory 120 may store data representing a point cloud.

Computer-readable medium 110 may represent any type of medium or device capable of transporting the encoded data from source device 102 to destination device 116. In one example, computer-readable medium 110 represents a communication medium to enable source device 102 to transmit encoded data directly to destination device 116 in real-time, e.g., via a radio frequency network or computer-based network. Output interface 108 may modulate a transmission signal including the encoded data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded data.

In some examples, source device 102 may output encoded data to file server 114 or another intermediate storage device that may store the encoded data generated by source device 102. Destination device 116 may access stored data from file server 114 via streaming or download. File server 114 may be any type of server device capable of storing encoded data and transmitting that encoded data to the destination device 116. File server 114 may represent a web server (e.g., for a website), a File Transfer Protocol (FTP) server, a content delivery network device, or a network attached storage (NAS) device. Destination device 116 may access encoded data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to G-PCC encoder 200 and/or output interface 108, and destination device 116 may include an SoC device to perform the functionality attributed to G-PCC decoder 300 and/or input interface 122.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

Input interface 122 of destination device 116 receives an encoded bitstream from computer-readable medium 110 (e.g., a communication medium, storage device 112, file server 114, or the like). The encoded bitstream may include signaling information defined by G-PCC encoder 200, which is also used by G-PCC decoder 300, such as syntax elements having values that describe characteristics and/or processing of coded units (e.g., slices, pictures, groups of pictures, sequences, or the like). Data consumer 118 uses the decoded data. For example, data consumer 118 may use the decoded data to determine the locations of physical objects. In some examples, data consumer 118 may comprise a display to present imagery based on a point cloud.

G-PCC encoder 200 and G-PCC decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of G-PCC encoder 200 and G-PCC decoder 300 may be included in one or more encoders or decoders, either of which may be integrated as part of a combined encoder/decoder (CODEC) in a respective device. A device including G-PCC encoder 200 and/or G-PCC decoder 300 may comprise one or more integrated circuits, microprocessors, and/or other types of devices.

G-PCC encoder 200 and G-PCC decoder 300 may operate according to a coding standard, such as video point cloud compression (V-PCC) standard or a geometry point cloud compression (G-PCC) standard. This disclosure may generally refer to coding (e.g., encoding and decoding) of pictures to include the process of encoding or decoding data. An encoded bitstream generally includes a series of values for syntax elements representative of coding decisions (e.g., coding modes).

This disclosure may generally refer to “signaling” certain information, such as syntax elements. The term “signaling” may generally refer to the communication of values for syntax elements and/or other data used to decode encoded data. That is, G-PCC encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

ISO/IEC MPEG (JTC 1/SC 29/WG 11) and more recently ISO/IEC MPEG 3DG (JTC 1/SC29/WG 7), is studying the potential need for standardization of point cloud coding technology with a compression capability that significantly exceeds that of the current approaches and will target to create the standard. The group is working together on this exploration activity in a collaborative effort known as the 3-Dimensional Graphics Team (3DG) to evaluate compression technology designs proposed by their experts in this area.

Point cloud compression activities are categorized in two different approaches. The first approach is “Video point cloud compression” (V-PCC), which segments the 3D object, and project the segments in multiple 2D planes (which are represented as “patches” in the 2D frame), which are further coded by a legacy 2D video codec such as a High Efficiency Video Coding (HEVC) (ITU-T H.265) codec. The second approach is “Geometry-based point cloud compression” (G-PCC), which directly compresses 3D geometry i.e., position of a set of points in 3D space, and associated attribute values (for each point associated with the 3D geometry). G-PCC addresses the compression of point clouds in both Category 1 (static point clouds) and Category 3 (dynamically acquired point clouds). A recent draft of the G-PCC standard is available in G-PCC DIS, ISO/IEC JTC1/SC29/WG11 w19088, Brussels, Belgium, January 2020, and a description of the codec is available in G-PCC Codec Description v6, ISO/IEC JTC1/SC29/WG11 w19091, Brussels, Belgium, January 2020. A recent working draft is available in WD 7.0 of G-PCC 2nd Edition, MDS23889_WG07_N00871.

A point cloud contains a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

The 3D space occupied by a point cloud data may be enclosed by a virtual bounding box. The position of the points in the bounding box may be represented by a certain precision; therefore, the positions of one or more points may be quantized based on the precision. At the smallest level, the bounding box is split into voxels which are the smallest unit of space represented by a unit cube. A voxel in the bounding box may be associated with zero, one, or more than one point. The bounding box may be split into multiple cube/cuboid regions, which may be called tiles. Each tile may be coded into one or more slices. The partitioning of the bounding box into slices and tiles may be based on number of points in each partition, or based on other considerations (e.g., a particular region may be coded as tiles). The slice regions may be further partitioned using splitting decisions similar to those in video codecs.

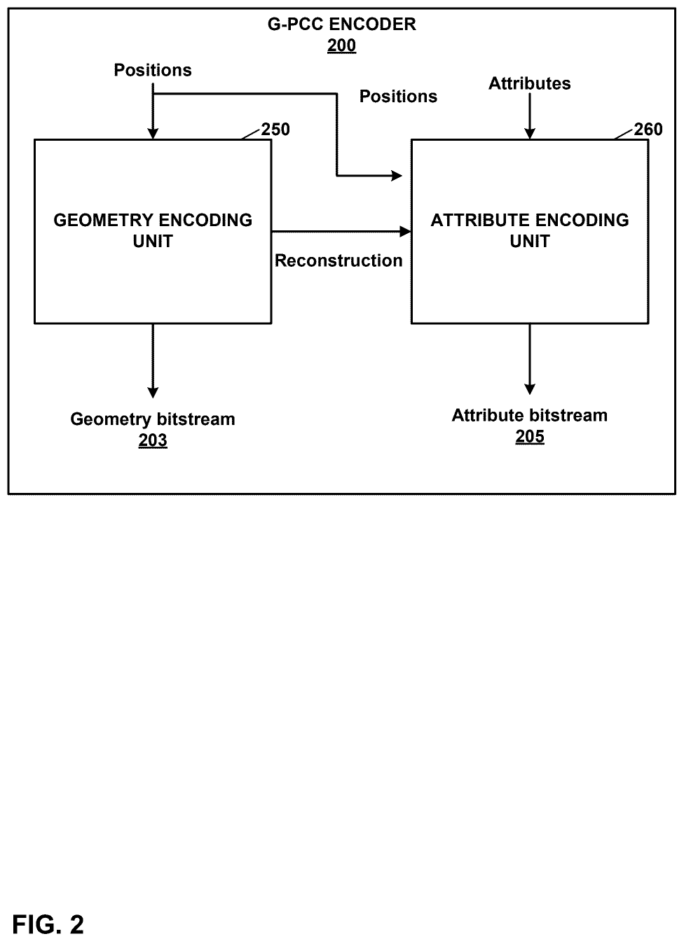

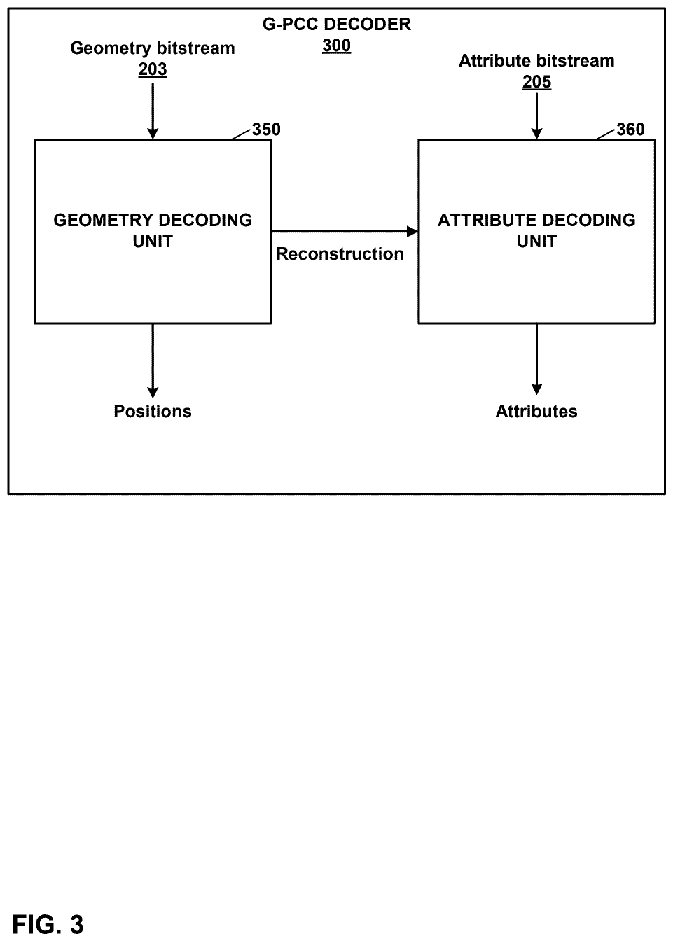

FIG. 2 provides an overview of G-PCC encoder 200. FIG. 3 provides an overview of G-PCC decoder 300. The modules shown are logical, and do not necessarily correspond one-to-one to implemented code. In the example of FIG. 2, G-PCC encoder 200 may include a geometry encoding unit 250 and an attribute encoding unit 260. In general, geometry encoding unit 250 is configured to encode the positions of points in the point cloud frame to produce geometry bitstream 203. Attribute encoding unit 260 is configured to encode the attributes of the points of the point cloud frame to produce attribute bitstream 205. As will be explained below, attribute encoding unit 260 may also use the positions, as well as the encoded geometry (e.g., the reconstruction) from geometry encoding unit 250 to encode the attributes.

In the example of FIG. 3, G-PCC decoder 300 may include a geometry decoding unit 350 and an attribute decoding unit 360. In general, geometry encoding unit 350 is configured to decode the geometry bitstream 203 to recover the positions of points in the point cloud frame. Attribute decoding unit 360 is configured to decode the attribute bitstream 205 to recover the attributes of the points of the point cloud frame. As will be explained below, attribute decoding unit 360 may also use the positions from the decoded geometry (e.g., the reconstruction) from geometry decoding unit 350 to encode the attributes.

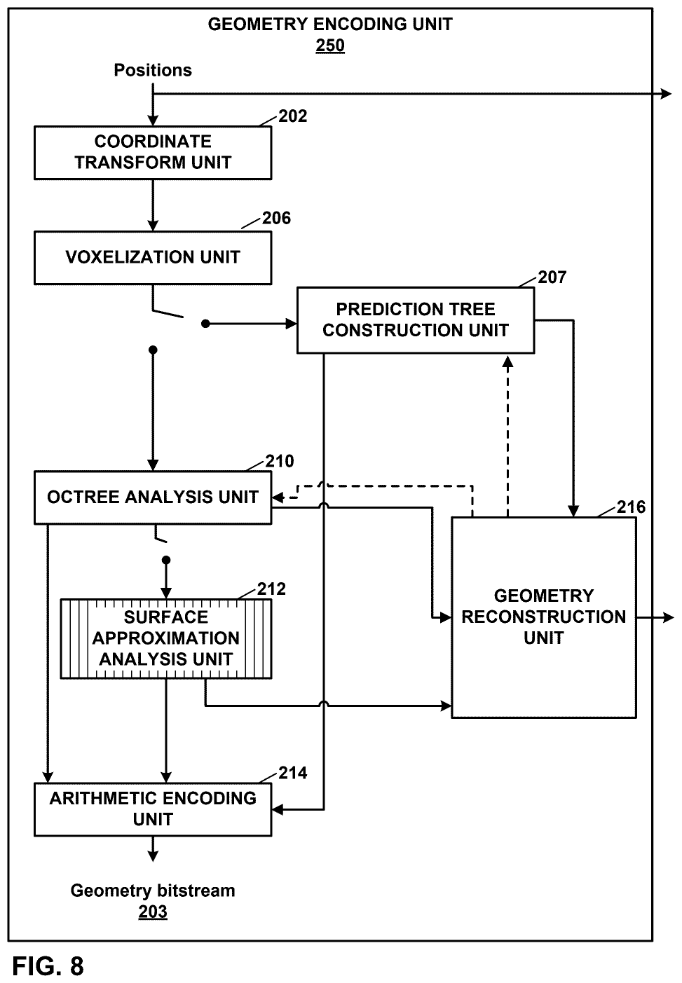

In both G-PCC encoder 200 and G-PCC decoder 300, point cloud positions are coded first. Attribute coding depends on the decoded geometry. In FIGS. 8-11 of this disclosure, the coding units with vertical hashing are options typically used for Category 1 data. Diagonal-crosshatched coding units are options typically used for Category 3 data. All the other modules are common between Categories 1 and 3.

For geometry, two different types of coding techniques exist: Octree and predictive-tree coding. In the following, the description is with respect to octree coding. For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

At each node of an octree, an occupancy is signaled (when not inferred) for one or more of its child nodes (up to eight nodes). Multiple neighborhoods are specified including (a) nodes that share a face with a current octree node, (b) nodes that share a face, edge or a vertex with the current octree node, etc. Within each neighborhood, the occupancy of a node and/or its children may be used to predict the occupancy of the current node or its children. For points that are sparsely populated in certain nodes of the octree, the codec also supports a direct coding mode where the 3D position of the point is encoded directly. A flag may be signaled to indicate that a direct mode is signaled. At the lowest level, the number of points associated with the octree node/leaf node may also be coded.

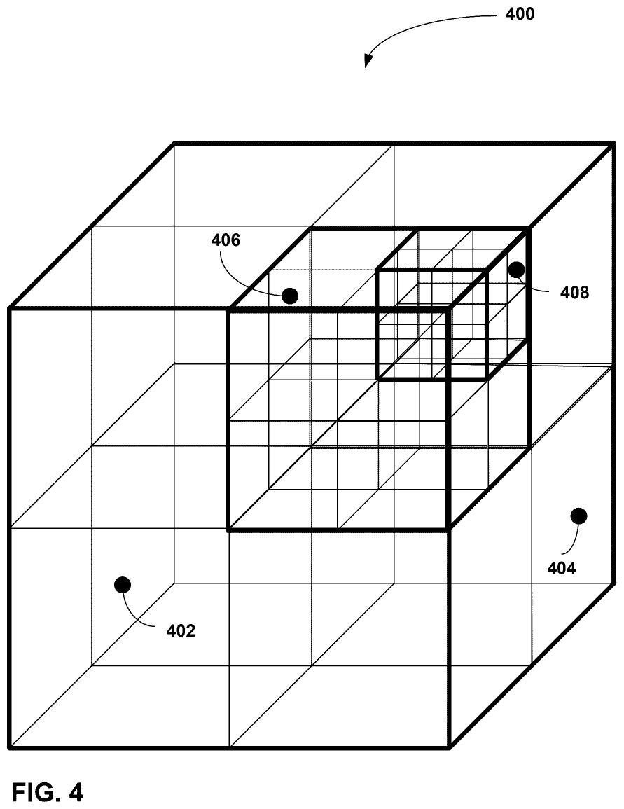

Once the geometry is coded, the attributes corresponding to the geometry points are coded. When there are multiple attribute points corresponding to one reconstructed/decoded geometry point, an attribute value may be derived that is representative of the reconstructed point. For instance, FIG. 4 illustrates octree split 400 for geometry coding, with points 402-408 each illustrating points at different levels of the octree split.

There are three attribute coding methods in G-PCC: Region Adaptive Hierarchical Transform (RAHT) coding, interpolation-based hierarchical nearest-neighbour prediction (Predicting Transform), and interpolation-based hierarchical nearest-neighbour prediction with an update/lifting step (Lifting Transform). RAHT and Lifting are typically used for Category 1 data, while Predicting is typically used for Category 3 data. However, either method may be used for any data, and just like with the geometry codecs in G-PCC, the attribute coding method used to code the point cloud is specified in the bitstream.

The coding of the attributes may be conducted in a level-of-detail (LoD), where with each level of detail a finer representation of the point cloud attribute may be obtained. Each level of detail may be specified based on distance metric from the neighboring nodes or based on a sampling distance.

At G-PCC encoder 200, the residuals obtained as the output of the coding methods for the attributes are quantized. The residuals may be obtained by subtracting the attribute value from a prediction that is derived based on the points in the neighborhood of the current point and based on the attribute values of points encoded previously. The quantized residuals may be coded using context adaptive arithmetic coding.

G-PCC encoder 200 and G-PCC decoder 300 may be configured to code point cloud data using predictive geometry coding as an alternative to the octree geometry coding. In prediction tree coding, the nodes of the point cloud are arranged in a tree structure (which defines the prediction structure), and various prediction strategies are used to predict the coordinates of each node in the tree with respect to its predictors.

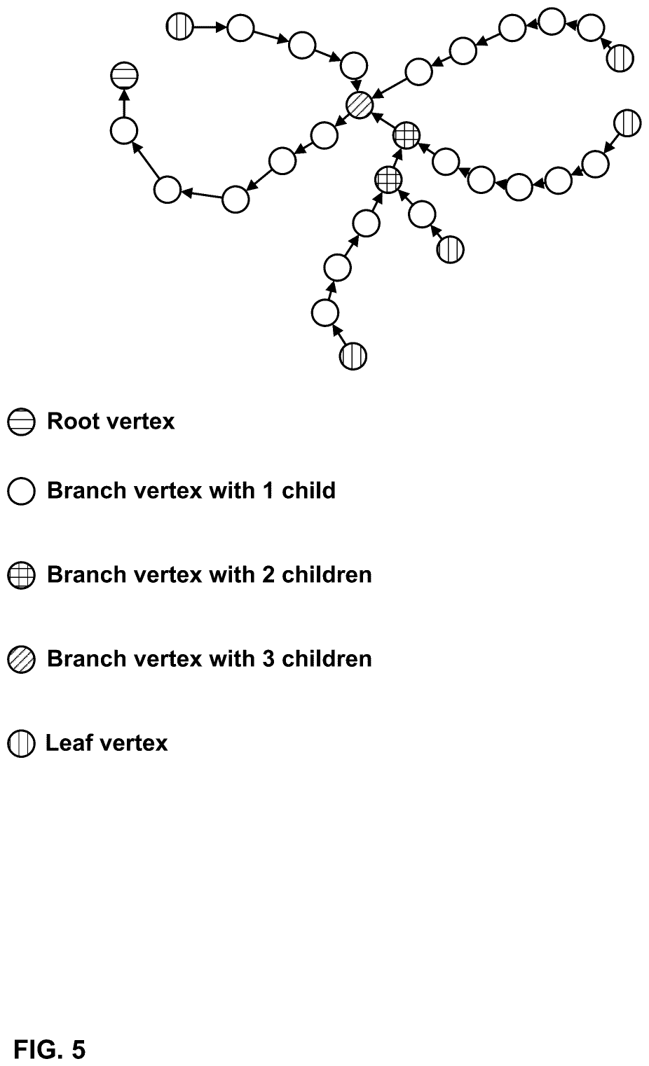

FIG. 5 is a conceptual diagram illustrating an example of a prediction tree. For instance, in FIG. 5 a directed graph where the arrow point to the prediction direction. An example node is the root vertex that has no predictors, another example of nodes have two children, another example of nodes has 3 children, another example of nodes have one child, and another example of nodes are leaf nodes and these have no children. Every node has only one parent node. In other words, a node that is the root vertex has no predictors. Other nodes may have 1, 2, 3 or more children. Other nodes may be leaf nodes that have no children. In one example, every node of the predictive has only one parent node.

In one example, four prediction strategies are specified for each node based on its parent (p0), grand-parent (p1) and great-grand-parent (p2):
No prediction/zero prediction (0)
Delta prediction (p0)
Linear prediction (2*p0−p1)
Parallelogram prediction (2*p0+p1−p2)

G-PCC encoder 200 may employ any algorithm to generate the prediction tree; the algorithm used may be determined based on the application/use case and several strategies may be used. For each node, the residual coordinate values are coded in the bitstream starting from the root node in a depth-first manner. Predictive geometry coding may be particularly useful for Category 3 (LIDAR-acquired) point cloud data, e.g., for low-latency applications.

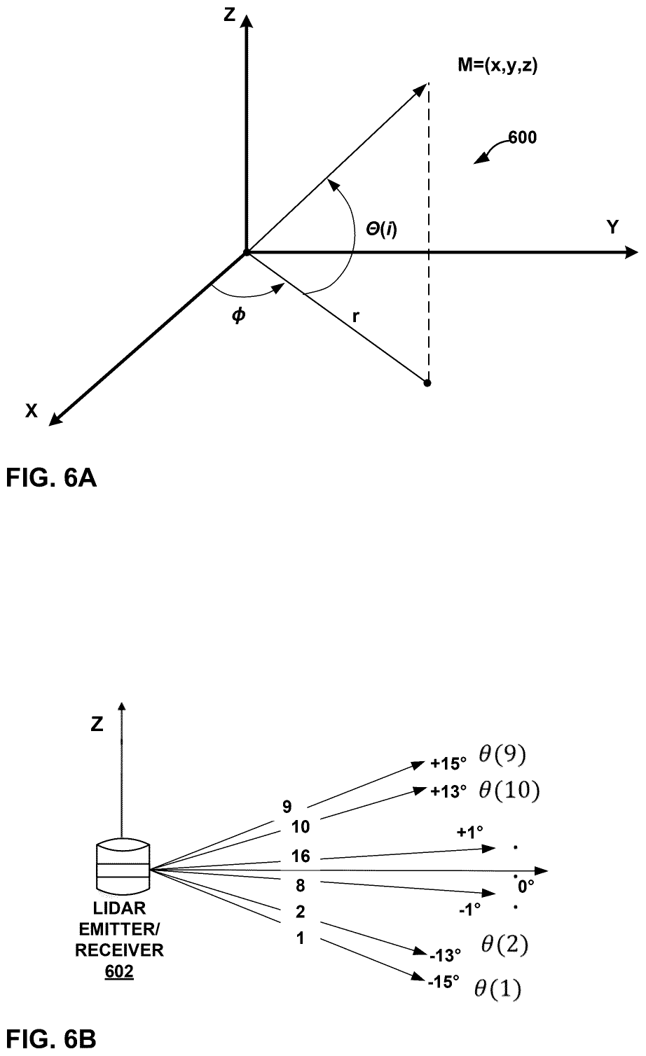

FIGS. 6A and 6B are conceptual diagrams illustrating an example of a spinning LIDAR acquisition model. LIDAR 602 may be used in automotive, mobile computing, aviation, and other scenarios. In some examples, angular mode may be used in predictive geometry coding, where the characteristics of LIDAR sensors may be utilized in coding the prediction tree more efficiently. The coordinates of the positions are converted to the (r, ϕ, i) (radius, azimuth and laser index) domain 600 and a prediction is performed in this domain 600 (the residuals are coded in r, ϕ, i domain). Due to the errors in rounding, coding in r, ϕ, i is not lossless and hence a second set of residuals are coded which correspond to the Cartesian coordinates. A description of the encoding and decoding strategies used for angular mode for predictive geometry coding is provided below.

Angular mode for predictive geometry coding may be used with point clouds acquired using a spinning LIDAR model. Here, the LIDAR 602 has N lasers (e.g., N=16, 32, 64) spinning around the Z axis according to an azimuth angle ϕ. Each laser may have different elevation θ(i)_{i=1 . . . N} and height ζ(i)_{i=1 . . . N}. In one example, laser i hits a point M, with cartesian integer coordinates (x,y,z), defined according to the coordinate system of an example spinning LIDAR acquisition model shown in FIGS. 6A and 6B.

Angular mode for predictive geometry coding may include modelling the position of M with three parameters (r, ϕ, i), which are computed as follows:

$$r = \sqrt{{x}^{2} + {y}^{2}}$$

$$ϕ = atan 2 ( y , x )$$

$$i = arg {min}_{j = 1 … N} \{ z + Ϛ ( j ) - r \times tan ( θ ( j ) ) \} ,$$

More precisely, angular mode for predictive geometry coding uses the quantized version of (r, ϕ, i), denoted (\tilde{r}, \tilde{ϕ}, i), where the three integers \tilde{r}, \tilde{ϕ} and i are computed as follows:

$$\tilde{r} = floor ( \frac{\sqrt{{x}^{2} + {y}^{2}}}{{q}_{r}} + {o}_{r} ) = hypot ( x , y )$$

$$\tilde{ϕ} = sign ( atan 2 ( y , x ) ) \times floor ( \frac{\vert atan 2 ( y , x ) \vert}{{q}_{ϕ}} + {o}_{ϕ} )$$

$$i = arg {min}_{j = 1 … N} \{ z + Ϛ ( j ) - r \times tan ( θ ( j ) ) \}$$

where:
(qᵣ, oᵣ) and (q_{ϕ}, o_{ϕ}) are quantization parameters controlling the precision of \tilde{ϕ} and \tilde{r}, respectively.
sign(t) is the function that return 1 if t is positive and (−1) otherwise.
   |t| is the absolute value of t.

To avoid reconstruction mismatches due to the use of floating-point operations, the values of ζ(i)_{i=1 . . . N} and tan(θ(i))_{i=1 . . . N} may be pre-computed and quantized as follows:

$$\tilde{z} ( i ) = sign ( Ϛ ( i ) ) \times floor ( \frac{\vert σ ( i ) \vert}{{q}_{Ϛ}} + {o}_{Ϛ} )$$

$$\tilde{t} ( i ) = sign ( Ϛ ( tan ( θ ( j ) ) ) \times floor ( \frac{\vert tan ( θ ( j ) \vert}{{q}_{θ}} + {o}_{θ} )$$

where:
(q_{ζ}, o_{ζ}) and (q_{θ}, o_{θ}) are quantization parameters controlling the precision of \tilde{ζ} and \tilde{θ}, respectively.

The reconstructed cartesian coordinates are obtained as follows:

$$\hat{x} = round ( \tilde{r} \times {q}_{r} \times app\_cos ( \tilde{ϕ} \times {q}_{ϕ} ) )$$

$$\hat{y} = round ( \tilde{r} \times {q}_{r} \times app\_sin ( \tilde{ϕ} \times {q}_{ϕ} ) )$$

$$\hat{z} = round ( \tilde{r} \times {q}_{r} \times \tilde{t} ( i ) \times {q}_{θ} - \tilde{z} ( i ) \times {q}_{Ϛ} ) ,$$

where app_cos(.) and app_sin(.) are approximation of cos(.) and sin(.). The calculations could be performed using a fixed-point representation, a look-up table, and linear interpolation.

Note that (\hat{x},ŷ,\hat{z}) may be different from (x,y,z) due to various reasons, for example:
quantization
approximations
model imprecision
model parameters imprecisions

Let (rₓ,r_{y},r_{z}) be the reconstruction residuals defined as follows:

$${r}_{x} = x - \hat{x}$$

$${r}_{y} = y - \hat{y}$$

$${r}_{z} = z - \hat{z}$$

In this method, G-PCC encoder 200 may proceed as follows:
Encode the model parameters \tilde{t}(i) and \tilde{z}(i) and the quantization parameters qᵣ q_{ζ}, q_{θ} and q_{ϕ}
Apply a geometry predictive scheme to the representation (\tilde{r},\tilde{ϕ},i)
   A new predictor leveraging the characteristics of LIDAR could be introduced. For instance, the rotation speed of the LIDAR scanner around the z-axis is usually constant. Therefore, G-PCC encoder 200 may predict the current \tilde{ϕ}(j) as follows:

$$\tilde{ϕ} ( j ) = \tilde{ϕ} ( j - 1 ) + n ( j ) \times {δ}_{ϕ} ( k )$$

Where
   (δ_{ϕ}(k))_{k=1 . . . K} is a set of potential speeds the encoder could choose from. The index k could be explicitly written to the bitstream or could be inferred from the context based on a deterministic strategy applied by both G-PCC encoder 200 and G-PCC decoder 300, and
   n(j) is the number of skipped points which could be explicitly written to the bitstream or could be inferred from the context based on a deterministic strategy applied by both the encoder and the decoder. It is also referred to as “phi multiplier” later. Note, it is currently used only with delta predictor.
Encode with each node the reconstruction residuals (rₓ,r_{y},r_{z})

G-PCC decoder 300 may proceed as follows:
Decode the model parameters \tilde{t}(i) and \tilde{z}(i) and the quantization parameters qᵣ q_{ζ}, q_{θ} and q_{ϕ}
Decode the (\tilde{r},\tilde{ϕ},i) parameters associated with the nodes according to the geometry predictive scheme used by G-PCC encoder 200.
Compute the reconstructed coordinates (\tilde{x},\tilde{y},\tilde{z}) as described above.
Decode the residuals (rₓ,r_{y},r_{z})
   As discussed in the next section, lossy compression could be supported by quantizing the reconstruction residuals (rₓ,r_{y},r_{z})
Compute the original coordinates (x,y,z) as follows

$$x = {r}_{x} + \hat{x}$$

$$y = {r}_{y} + \hat{y}$$

$$z = {r}_{z} + \hat{z}$$

Lossy compression may be achieved by applying quantization to the reconstruction residuals (rₓ,r_{y},r_{z}) or by dropping points.

The quantized reconstruction residuals may be computed as follows:

$${\tilde{r}}_{x} = sign ( {r}_{x} ) \times floor ( \frac{\vert {r}_{x} \vert}{{q}_{x}} + {o}_{x} )$$

$${\tilde{r}}_{y} = sign ( {r}_{y} ) \times floor ( \frac{\vert {r}_{y} \vert}{{q}_{y}} + {o}_{y} )$$

$${\tilde{r}}_{z} = sign ( {r}_{z} ) \times floor ( \frac{\vert {r}_{z} \vert}{{q}_{z}} + {o}_{z} )$$

Where (qₓ, oₓ), (q_{y}, o_{y}) and (q_{z}, o_{z}) are quantization parameters controlling the precision of \hat{r}ₓ, \tilde{r}_{y} and \tilde{r}_{z}, respectively.

Trellis quantization may be used to further improve the RD (rate-distortion) performance results. The quantization parameters may change at sequence/frame/slice/block level to achieve region adaptive quality and for rate control purposes.

The attribute coding, octree geometry coding, and predictive tree geometry coding techniques may be performed as intra prediction coding techniques. That is, G-PCC encoder 200 and G-PCC decoder 300 may code attribute and position data using only information from the frame of point cloud data being coded. In other examples, G-PCC encoder 200 and G-PCC decoder 300 may attributes, octree geometry, and/or predictive tree geometry using inter prediction techniques. That is, G-PCC encoder 200 and G-PCC decoder 300 may code attribute and position data using information from the frame of point cloud data being coded as well as information from previously-coded frames of point cloud data.

As described above, one example of predictive geometry coding uses a prediction tree structure to predict the positions of the points. When angular coding is enabled, the x, y, z coordinates are transformed to radius, azimuth and laserID and residuals are signaled in these three coordinates as well as in the x, y, z dimensions. The intra prediction used for radius, azimuth and laserID may be one of four modes and the predictors are the nodes that are classified as parent, grand-parent and great-grandparent in the prediction tree with respect to the current node. In one example, predictive geometry coding may be configured as an intra coding tool as it only uses points in the same frame for prediction. However, using points from previously-decoded frames (e.g., inter-prediction) may provide a better prediction and thus better compression performance in some circumstances.

For predictive geometry coding using inter prediction, one technique involves predicting the radius of a point from a reference frame. For each point in the prediction tree, it is determined whether the point is inter predicted or intra predicted (indicated by a flag). When intra predicted, the intra prediction modes of predictive geometry coding are used. When inter-prediction is used, the azimuth and laserID are still predicted with intra prediction, while the radius is predicted from the point in the reference frame that has the same laserID as the current point and an azimuth that is closest to the current azimuth. Another example of this method enables inter prediction of the azimuth and laserID in addition to radius prediction. When inter-coding is applied, the radius, azimuth and laserID of the current point are predicted based on a point that is near the azimuth position of a previously decoded point in the reference frame. In addition, separate sets of contexts are used for inter and intra prediction.

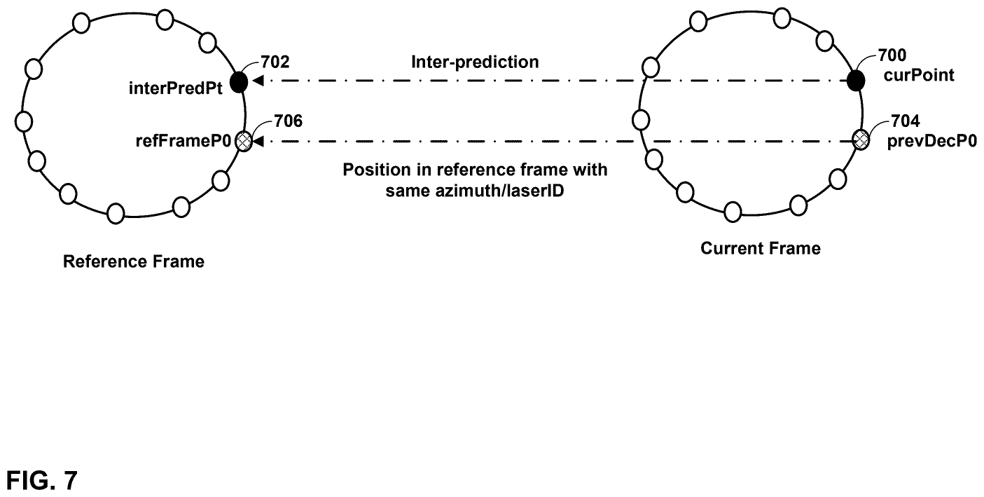

A method is illustrated in FIG. 7. FIG. 7 is a conceptual diagram illustrating an example of inter-prediction of a current point (curPoint) 700 in a current frame from a point (interPredPt) 702 in the reference frame. The extension of inter prediction to azimuth, radius, and laserID may include the following steps:
For a given point, choose the previous decoded point (prevDecP0) 704.
Choose a position point (refFrameP0) 706 in the reference frame that has same scaled azimuth and laserID as prevDecP0 704.
In the reference frame, find the first point (interPredPt) 702 that has azimuth greater than that of refFrameP0 706. The point interPredPt 702 may also be referred to as the “Next” inter predictor.

FIG. 8 is a block diagram illustrating an example of geometry encoding unit 250 of FIG. 2 in more detail. Geometry encoding unit 250 may include a coordinate transform unit 202, a voxelization unit 206, a predictive tree construction unit 207, an octree analysis unit 210, a surface approximation analysis unit 212, an arithmetic encoding unit 214, and a geometry reconstruction unit 216.

As shown in the example of FIG. 8, geometry encoding unit 250 may obtain a set of positions of points in the point cloud. In one example, geometry encoding unit 250 may obtain the set of positions of the points in the point cloud and the set of attributes from data source 104 (FIG. 1). The positions may include coordinates of points in a point cloud. Geometry encoding unit 250 may generate a geometry bitstream 203 that includes an encoded representation of the positions of the points in the point cloud.

Coordinate transform unit 202 may apply a transform to the coordinates of the points to transform the coordinates from an initial domain to a transform domain. This disclosure may refer to the transformed coordinates as transform coordinates. Voxelization unit 206 may voxelize the transform coordinates. Voxelization of the transform coordinates may include quantization and removing some points of the point cloud. In other words, multiple points of the point cloud may be subsumed within a single “voxel,” which may thereafter be treated in some respects as one point.

Prediction tree construction unit 207 may be configured to generate a prediction tree based on the voxelized transform coordinates. Prediction tree construction unit 207 may be configured to perform any of the prediction tree coding techniques described above, either in an intra-prediction mode or an inter-prediction mode. In order to perform prediction tree coding using inter-prediction, prediction tree construction unit 207 may access points from previously-encoded frames from geometry reconstruction unit 216. Dashed lines from geometry reconstruction unit 216 show data paths when inter-prediction is performed. Arithmetic encoding unit 214 may entropy encode syntax elements representing the encoded prediction tree.

Instead of performing prediction tree based coding, geometry encoding unit 250 may perform octree based coding. Octree analysis unit 210 may generate an octree based on the voxelized transform coordinates. Surface approximation analysis unit 212 may analyze the points to potentially determine a surface representation of sets of the points. Arithmetic encoding unit 214 may entropy encode syntax elements representing the information of the octree and/or surfaces determined by surface approximation analysis unit 212. Geometry encoding unit 250 may output these syntax elements in geometry bitstream 203. Geometry bitstream 203 may also include other syntax elements, including syntax elements that are not arithmetically encoded.

Octree-based coding may be performed either as intra-prediction techniques or inter-prediction techniques. In order to perform octree tree coding using inter-prediction, octree analysis unit 210 and surface approximation analysis unit 212 may access points from previously-encoded frames from geometry reconstruction unit 216. Dashed lines from geometry reconstruction unit 216 show data paths when inter-prediction is performed.

Geometry reconstruction unit 216 may reconstruct transform coordinates of points in the point cloud based on the octree, the predictive tree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points.

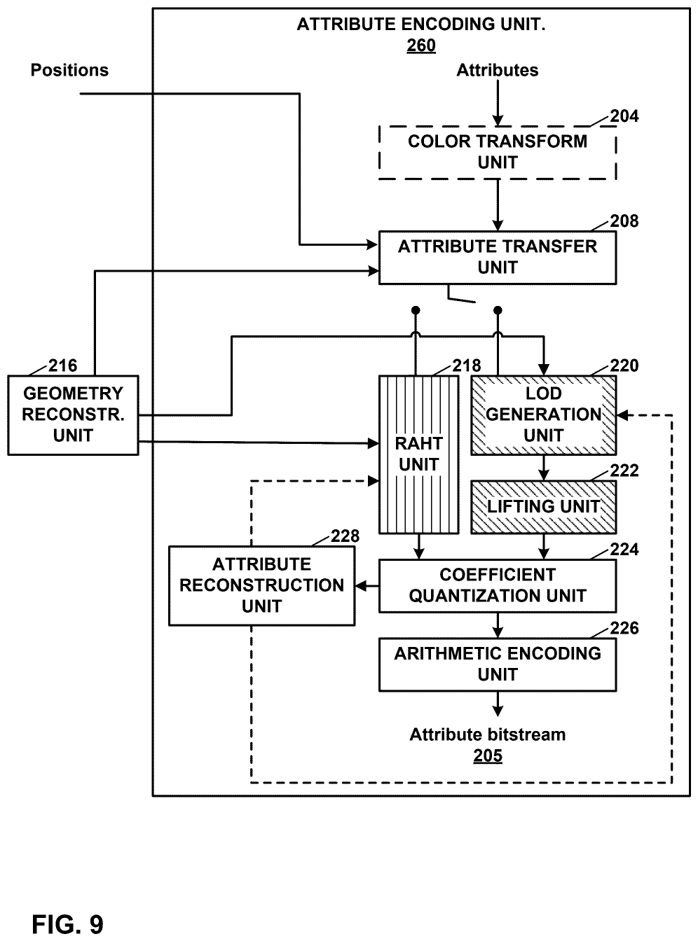

FIG. 9 is a block diagram illustrating an example of attribute encoding unit 260 of FIG. 2 in more detail. Attribute encoding unit 250 may include a color transform unit 204, an attribute transfer unit 208, an RAHT unit 218, a LoD generation unit 220, a lifting unit 222, a coefficient quantization unit 224, an arithmetic encoding unit 226, and an attribute reconstruction unit 228. Attribute encoding unit 260 may encode the attributes of the points of a point cloud to generate an attribute bitstream 205 that includes an encoded representation of the set of attributes. The attributes may include information about the points in the point cloud, such as colors associated with points in the point cloud.

Color transform unit 204 may apply a transform to transform color information of the attributes to a different domain. For example, color transform unit 204 may transform color information from an RGB color space to a YCbCr color space. Attribute transfer unit 208 may transfer attributes of the original points of the point cloud to reconstructed points of the point cloud. Attribute transfer unit 208 may use the original positions of the points as well as the positions generated from attribute encoding unit 250 (e.g., from geometry reconstruction unit 216) to make the transfer.

RAHT unit 218 may apply RAHT coding to the attributes of the reconstructed points. In some examples, under RAHT, the attributes of a block of 2×2×2 point positions are taken and transformed along one direction to obtain four low (L) and four high (H) frequency nodes. Subsequently, the four low frequency nodes (L) are transformed in a second direction to obtain two low (LL) and two high (LH) frequency nodes. The two low frequency nodes (LL) are transformed along a third direction to obtain one low (LLL) and one high (LLH) frequency node. The low frequency node LLL corresponds to DC coefficients and the high frequency nodes H, LH, and LLH correspond to AC coefficients. The transformation in each direction may be a 1-D transform with two coefficient weights. The low frequency coefficients may be taken as coefficients of the 2×2×2 block for the next higher level of RAHT transform and the AC coefficients are encoded without changes; such transformations continue until the top root node. The tree traversal for encoding is from top to bottom used to calculate the weights to be used for the coefficients; the transform order is from bottom to top. The coefficients may then be quantized and coded.

Alternatively or additionally, LoD generation unit 220 and lifting unit 222 may apply LoD processing and lifting, respectively, to the attributes of the reconstructed points. LoD generation is used to split the attributes into different refinement levels. Each refinement level provides a refinement to the attributes of the point cloud. The first refinement level provides a coarse approximation and contains few points; the subsequent refinement level typically contains more points, and so on. The refinement levels may be constructed using a distance-based metric or may also use one or more other classification criteria (e.g., subsampling from a particular order). Thus, all the reconstructed points may be included in a refinement level. Each level of detail is produced by taking a union of all points up to particular refinement level: e.g., LoD1 is obtained based on refinement level RL1, LoD2 is obtained based on RL1 and RL2, . . . . LoDN is obtained by union of RL1, RL2, . . . . RLN. In some cases, LoD generation may be followed by a prediction scheme (e.g., predicting transform) where attributes associated with each point in the LoD are predicted from a weighted average of preceding points, and the residual is quantized and entropy coded. The lifting scheme builds on top of the predicting transform mechanism, where an update operator is used to update the coefficients and an adaptive quantization of the coefficients is performed.

RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. G-PCC encoder 200 may output these syntax elements in attribute bitstream 205. Attribute bitstream 205 may also include other syntax elements, including non-arithmetically encoded syntax elements.

Like geometry encoding unit 250, attribute encoding unit 260 may encode the attributes using either intra-prediction or inter-prediction techniques. The above description of attribute encoding unit 260 generally describes intra-prediction techniques. In other examples, RAHT unit 215, LoD generation unit 220, and/or lifting unit 222 may also use attributes from previously-encoded frames to further encode the attributes of the current frame. In this regard, attribute reconstructions unit 228 may be configured to reconstruct the encoded attributes and store them for possible future use in inter-prediction encoding. Dashed lines from attribute reconstruction unit 228 show data paths when inter-prediction is performed.

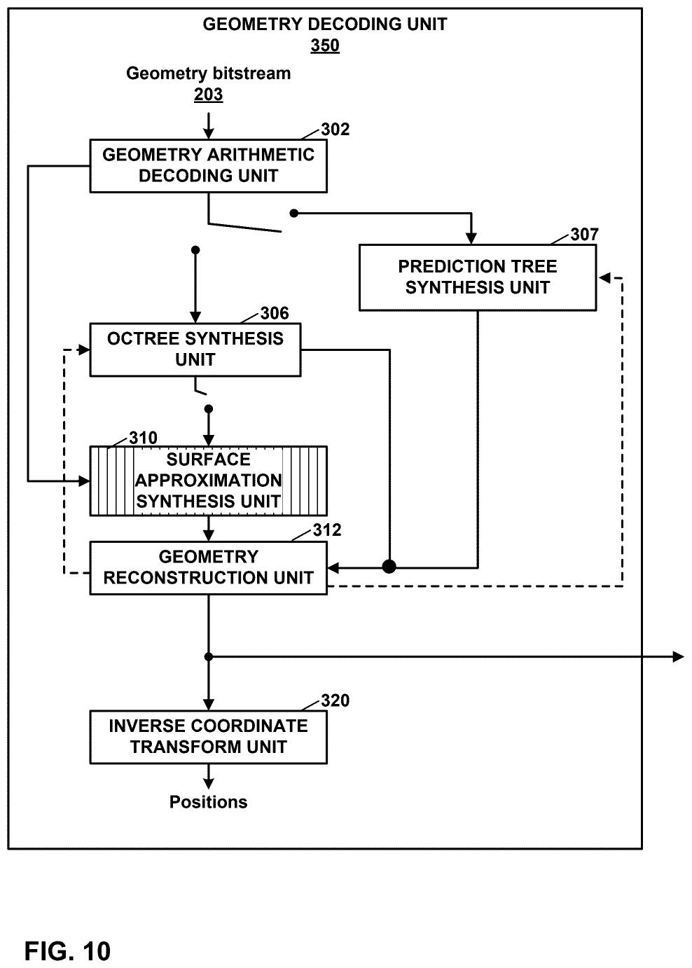

FIG. 10 is a block diagram illustrating an example geometry decoding unit 350 of FIG. 3 in more detail. Geometry decoding unit 350 may be configured to perform the reciprocal process to that performed by geometry encoding unit 250 of FIG. 8. Geometry decoding unit 350 receives geometry bitstream 203 and produces positions of the points of a point cloud frame. Geometry decoding unit 350 may include a geometry arithmetic decoding unit 302, an octree synthesis unit 306, a prediction tree synthesis unit 307, a surface approximation synthesis unit 310, a geometry reconstruction unit 312, and an inverse coordinate transform unit 320.

Geometry decoding unit 350 may receive geometry bitstream 203. Geometry arithmetic decoding unit 302 may apply arithmetic decoding (e.g., Context-Adaptive Binary Arithmetic Coding (CABAC) or other type of arithmetic decoding) to syntax elements in geometry bitstream 203.

Octree synthesis unit 306 may synthesize an octree based on syntax elements parsed from geometry bitstream 203. Starting with the root node of the octree, the occupancy of each of the eight children node at each octree level is signaled in the bitstream. When the signaling indicates that a child node at a particular octree level is occupied, the occupancy of children of this child node is signaled. The signaling of nodes at each octree level is signaled before proceeding to the subsequent octree level.

At the final level of the octree, each node corresponds to a voxel position; when the leaf node is occupied, one or more points may be specified to be occupied at the voxel position. In some instances, some branches of the octree may terminate earlier than the final level due to quantization. In such cases, a leaf node is considered an occupied node that has no child nodes. In instances where surface approximation is used in geometry bitstream 203, surface approximation synthesis unit 310 may determine a surface model based on syntax elements parsed from geometry bitstream 203 and based on the octree.

Octree-based coding may be performed either as intra-prediction techniques or inter-prediction techniques. In order to perform octree tree coding using inter-prediction, octree synthesis unit 306 and surface approximation synthesis unit 310 may access points from previously-decoded frames from geometry reconstruction unit 312. Dashed lines from geometry reconstruction unit 312 show data paths when inter-prediction is performed.

Prediction tree synthesis unit 307 may synthesize a prediction tree based on syntax elements parsed from geometry bitstream 203. Prediction tree synthesis unit 307 may be configured to synthesize the prediction tree using any of the techniques described above, including using both intra-prediction techniques or intra-prediction techniques. In order to perform prediction tree coding using inter-prediction, prediction tree synthesis unit 307 may access points from previously-decoded frames from geometry reconstruction unit 312. Dashed lines from geometry reconstruction unit 312 show data paths when inter-prediction is performed.

Geometry reconstruction unit 312 may perform a reconstruction to determine coordinates of points in a point cloud. For each position at a leaf node of the octree, geometry reconstruction unit 312 may reconstruct the node position by using a binary representation of the leaf node in the octree. At each respective leaf node, the number of points at the respective leaf node is signaled; this indicates the number of duplicate points at the same voxel position. When geometry quantization is used, the point positions are scaled for determining the reconstructed point position values.

Inverse transform coordinate unit 320 may apply an inverse transform to the reconstructed coordinates to convert the reconstructed coordinates (positions) of the points in the point cloud from a transform domain back into an initial domain. The positions of points in a point cloud may be in floating point domain but point positions in G-PCC codec are coded in the integer domain. The inverse transform may be used to convert the positions back to the original domain.

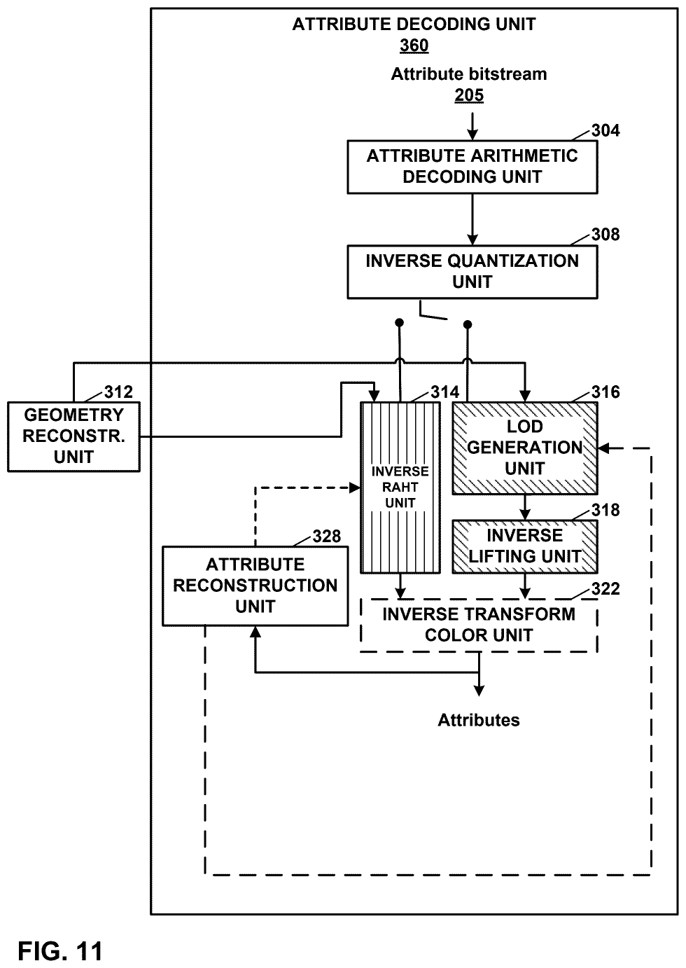

FIG. 11 is a block diagram illustrating an example attribute decoding unit 360 of FIG. 3 in more detail. Attribute decoding unit 360 may be configured to perform the reciprocal process to that performed by attribute encoding unit 260 of FIG. 9. Attribute decoding unit 360 receives attribute bitstream 205 and produces attributes of the points of a point cloud frame. Attribute decoding unit 356 may include an attribute arithmetic decoding unit 304, an inverse quantization unit 308, an inverse RAHT unit 314, an LoD generation unit 316, an inverse lifting unit 318, an inverse transform color unit 322, and an attribute reconstruction unit 328.

Attribute arithmetic decoding unit 304 may apply arithmetic decoding to syntax elements in attribute bitstream 205. Inverse quantization unit 308 may inverse quantize attribute values. The attribute values may be based on syntax elements obtained from attribute bitstream 205 (e.g., including syntax elements decoded by attribute arithmetic decoding unit 304).

Depending on how the attribute values are encoded, inverse RAHT unit 314 may perform RAHT coding to determine, based on the inverse quantized attribute values, color values for points of the point cloud. RAHT decoding is done from the top to the bottom of the tree. At each level, the low and high frequency coefficients that are derived from the inverse quantization process are used to derive the constituent values. At the leaf node, the values derived correspond to the attribute values of the coefficients. The weight derivation process for the points is similar to the process used at G-PCC encoder 200. Alternatively, LoD generation unit 316 and inverse lifting unit 318 may determine color values for points of the point cloud using a level of detail-based technique. LoD generation unit 316 decodes each LoD giving progressively finer representations of the attribute of points. With a predicting transform, LoD generation unit 316 derives the prediction of the point from a weighted sum of points that are in prior LoDs, or previously reconstructed in the same LoD. LoD generation unit 316 may add the prediction to the residual (which is obtained after inverse quantization) to obtain the reconstructed value of the attribute. When the lifting scheme is used, LoD generation unit 316 may also include an update operator to update the coefficients used to derive the attribute values. LoD generation unit 316 may also apply an inverse adaptive quantization in this case.

Furthermore, in the example of FIG. 11, inverse transform color unit 322 may apply an inverse color transform to the color values. The inverse color transform may be an inverse of a color transform applied by color transform unit 204 of G-PCC encoder 200. For example, color transform unit 204 may transform color information from an RGB color space to a YCbCr color space. Accordingly, inverse color transform unit 322 may transform color information from the YcbCr color space to the RGB color space.

Attribute reconstruction unit 328 may be configured to store attributes from previously-decoded frames. Attribute coding may be performed either as intra-prediction techniques or inter-prediction techniques. In order to perform attribute decoding using inter-prediction, inverse RAHT unit 314 and/or LoD generation unit 316 may access attributes from previously-decoded frames from attribute reconstruction unit 328. Dashed lines from attribute reconstruction unit 328 show data paths when inter-prediction is performed.

The various units of FIGS. 8-11 are illustrated to assist with understanding the operations performed by G-PCC encoder 200 and G-PCC decoder 300. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

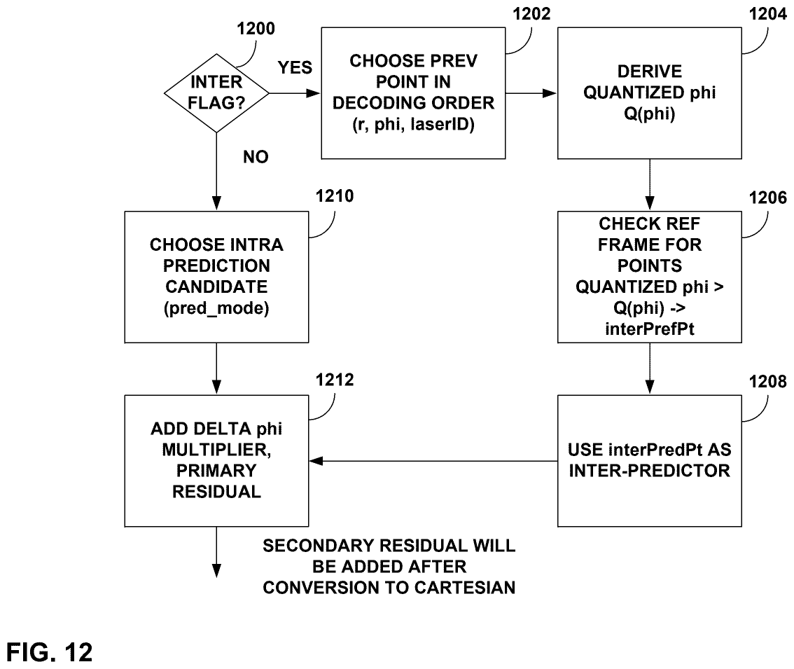

FIG. 12 is a flow diagram illustrating an example of decoding point cloud data. For example, FIG. 12 illustrates the decoding flow associated with the “inter_flag” that is signaled for every point. The example of FIG. 12 may be similar to examples available in InterEM-v3.0.

For example, in FIG. 12, G-PCC decoder 300 may determine whether current point is to be decoded using inter-prediction or intra-prediction based on a flag (1200). If inter-prediction (YES of 1200), G-PCC decoder 300 may choose previous point in decoding order in the current frame, including the radius component (r), azimuth component (phi), and laser identification component (laserID) (1202), and derive a quantized azimuth (e.g., phi) (1204). G-PCC decoder 300 may check a reference frame for points that have a greater quantized azimuth (e.g., the points are interPredPt) (1206), and use one or more of interPredPt as inter-predictor (1208). G-PCC decoder 300 may add delta azimuth multiplier to primary residual (1212).

If not inter-prediction (NO of 1200), G-PCC decoder 300 may choose intra-prediction candidate (e.g., pred_mode) (1210). G-PCC decoder 300 may add delta azimuth multiplier to primary residual (1212). G-PCC decoder 300 may add a secondary residual after a conversion back to Cartesian coordinates.

The following describes examples of determining an additional predictor candidate. In the inter prediction method for predictive geometry described above for inter-prediction for predictive geometry coding, the radius, azimuth and laserID of the current point are predicted based on a point that is near the collocated azimuth position in the reference frame when inter coding is applied using the following steps: (a) for a given point, choose the previous decode point, (b) choose a position in the reference frame that has the same scaled azimuth and laserID as (a), and (c) choose a position in the reference frame from the first point that has azimuth greater than the position in b), to be used as the inter predictor point.

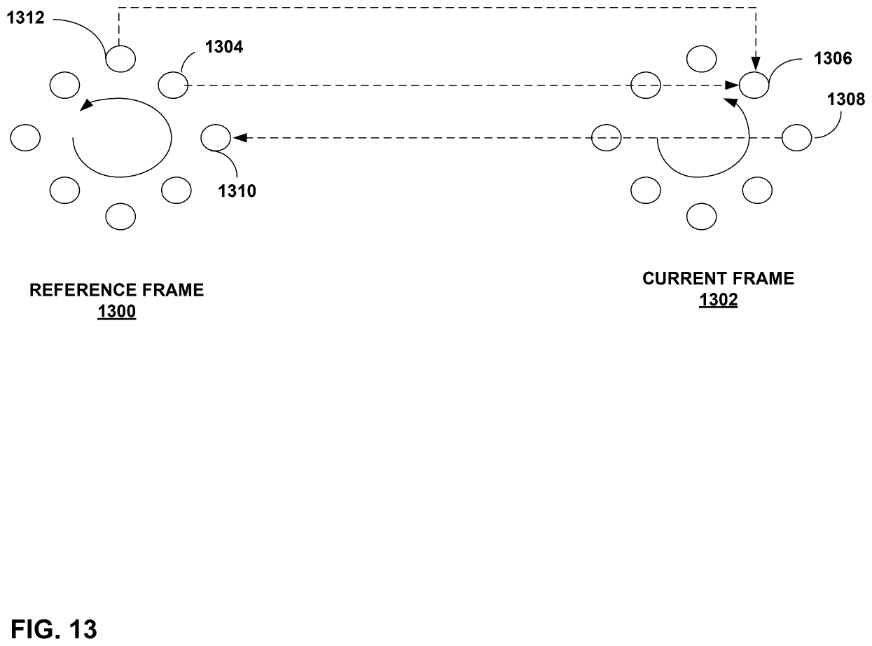

The example techniques add an additional inter predictor point that is obtained by finding the first point that has azimuth greater than the inter predictor point in c) as shown in FIG. 13. Additional signaling is used to indicate which of the predictors is selected if inter coding has been applied. The additional inter pred point is also referred to as the “NextNext” inter predictor.

For example, in FIG. 13, current frame 1302 includes current point 1306, with previous decoded point 1308. Point 1310 in reference frame 1300 is a reference point with same scaled azimuth and laserID as that for current frame 1302. Additional inter-prediction point 1312 of reference frame 1300 may also be used for inter-prediction of current point 1306.

The following describes improved inter-prediction flag coding. An improved context selection algorithm is applied for coding the inter prediction flag. The inter prediction flag values of the five previously coded points are used to select the context of the inter prediction flag in predictive geometry coding.

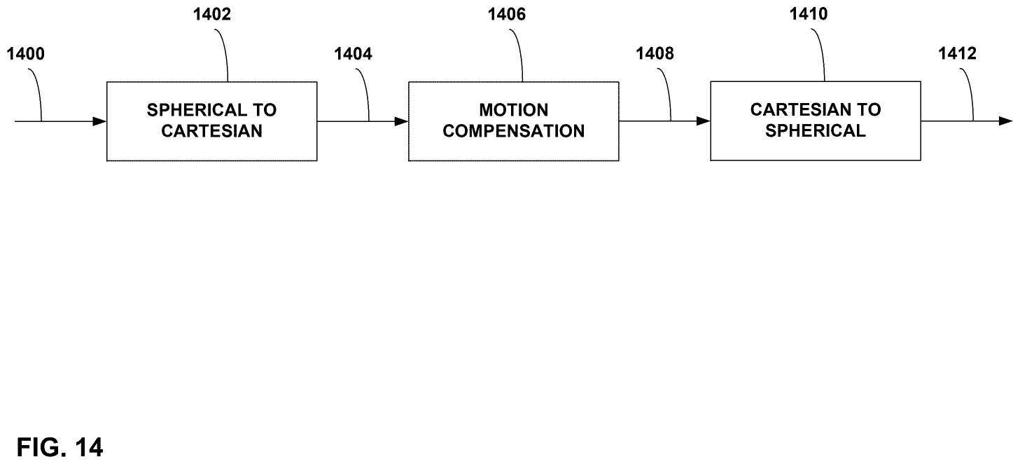

The following describes global motion compensation. When global motion (GM) parameters are available, inter prediction may be applied using a reference frame that is motion compensated using the GM parameters. The GM parameters may include rotation parameters and/or translation parameters. Typically, the global motion compensation is applied in the Cartesian domain. In some cases, the global motion compensation may also be conducted in the spherical domain. Depending on which domain the reference frame is stored, and which domain the reference frame is compensated, one or more of Cartesian to Spherical domain conversion, or Spherical to Cartesian domain conversion may be applied. For example, when the reference frame is stored in spherical domain, and the motion compensation is performed in the cartesian domain, the motion compensation process may involve one or more of the following steps illustrated in FIG. 14.

For instance, in FIG. 14, reference frame in spherical domain (1400) is input for spherical to cartesian domain conversion (1402). The output may be a reference frame in cartesian domain (1404). The reference frame in cartesian domain may be motion compensated (1406), and the output maybe a compensated reference frame in cartesian domain (1408). The compensated reference frame in cartesian domain (1408) may be input for cartesian to spherical domain conversion (1410). The output may be a compensated reference frame in spherical domain (1412).

In such cases, the compensated reference frame may be used for inter prediction. Given a position (x,y,z) in cartesian coordinate system, the corresponding radius and azimuthal angle are calculated (floating point implementation) as follows (As in CartesianToSpherical conversion function):

$$int64\_tr 0 = int64\_t ( std \text{::} round ( hypot ( xyz [ 0 ] , xyz [ 1 ] ) ) ) ;$$

$$auto phi 0 = std \text{::} round ( ( a tan 2 ( xyz [ 1 ] , xyz [ 0 ] ) / ( 2. * M\_PI ) ) * scalePhi ) ;$$

where, scalePhi is modified for different rate points in the lossy configuration; a maximum value of 24 bits is used for azimuth angle when coding the geometry losslessly. The fixed-point implementation of the azimuth is available in convertXyZToRpl function.

### Radius:

| Floating | int64_t r0 = int64_t(std::round(hypot(xyz[0], |
|---|---|
| implementation | xyz[1]))); |
| Fixed point | int64_t xLaser= xyz[0] << 8; |
| implementation | int64_t yLaser= xyz[1] << 8; |
| (in convertXyzToRpl) | int64_t r0 = isqrt(xLaser * xLaser + yLaser * |
| | yLaser) >> 8; |
| Floating | auto phi0 = std::round((atan2(xyz[1], xyz[0]) / |
| implementation | (2.0 * M_PI)) * scalePhi); |
| Fixed point | (*dst)[1] = (iatan2(yLaser, xLaser) + |
| implementation | 3294199) >> 8; |
| (in convertXyzToRpl) | |

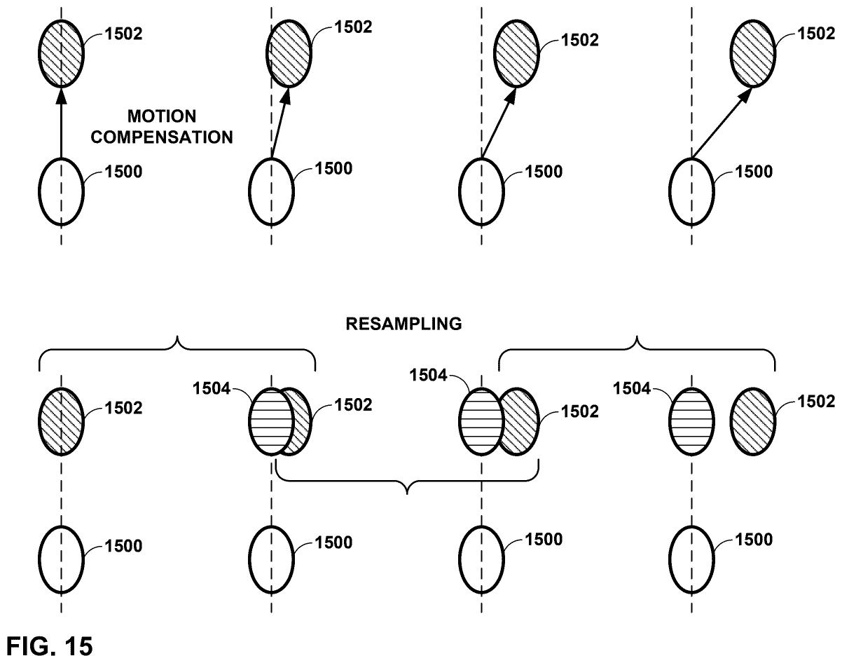

The following describes resampling of a reference frame. When global motion compensation is applied, the azimuth position of the points are modified depending on the motion parameters. Therefore, resampling may be needed to align the azimuth points before and after compensation as illustrated in FIG. 15.

The non-filled ovals represent points 1500 in an uncompensated reference frame (e.g., a reference frame without, or prior to, any global motion compensation being applied). The diagonal-line-filled ovals represent points 1502 in a global motion compensated version of the reference frame. The horizontal-line-filled ovals represent resampled points 1504 of the global motion compensated version of the reference frame. Thus, points 1500 have no global motion compensation applied, points 1502 have global motion compensation applied, and points 1504 have global motion compensation and resampling applied. As can be seen, the application of global motion compensation may cause the azimuth position of one or more of points 1502 to become misaligned with respective points of points 1500. By resampling, G-PCC encoder 200 or G-PCC decoder 300 may realign points 1502 (e.g., shown as resampled points 1504) with their respective points 1500.

The resampling process may be applied for each point P in the uncompensated reference frame as follows:
a. Let A_ref be the azimuth value and L be the laser ID value associated with the point P.
b. If there is a point P1 in the (global motion-) compensated reference frame that has azimuth value equal to A_ref and laser ID equal to L, the radius of the point P is set equal to the radius of point P1.
c. Else, two points P2 and P3 are chosen in the (global motion-) compensated reference frame with laser ID L such that azimuth of the P2 is less than A_ref, azimuth of P3 is greater than A_ref. The radius of point P is set equal to a weighted interpolation of radii of points P2 and P3; the weights used for the interpolation is dependent on the difference between A_ref and the azimuth value of P2 and P3.

The resultant reference frame (obtained by resampling the uncompensated reference frame with radius values from the compensated reference frame), referred to as the resampled reference frame, is used to predict the inter prediction candidates. The two inter predictor candidates may therefore be indicated as [Res-Next, Res-NextNext], where the first part “Res” indicates that the candidates are obtained from the resampled reference frame and the second part “Next”/“NextNext” indicate the particular candidate in the reference frame, as described above.

The following describes additional candidates for inter prediction. A modified inter predictor list may be used where four inter prediction candidates are specified as follows: [Zero-Next, Zero-NextNext, Glob-Next, Glob-NextNext].

The prefix “Zero” for the first two candidates indicates that the candidates are obtained directly from uncompensated reference frame (no motion compensation or resampling) and the prefix “Glob” for the last two candidates indicates that the candidates are obtained directly from global-motion-compensated reference frame.

The following describes a flag for signaling resampling, gm, to indicate 2/4 candidate. A flag was enabled to indicate whether resampling is enabled or not. Moreover, when global motion was disabled for the sequence, only two inter prediction candidates were allowed. Thus, the inter prediction candidates for predictive geometry coding were chosen as follows:
a. Global motion disabled:
   i. [Zero-Next, Zero-NextNext]
b. Global motion enabled
   i. Resampling enabled
      1. [Res-Next, Res-NextNext, Glob-Next, Glob-NextNext]
   ii. Resampling disabled
      1. [Zero-Next, Zero-NextNext, Glob-Next, Glob-NextNext]

The prefix “Res” for the first two candidates when both global motion and resampling is enabled indicates that the candidates are obtained from resampled reference frame.

The following describes spherical coordinate conversion (SCC). Spherical coordinate conversion is a technique used in G-PCC where geometry represented in the spherical coordinate system is used during attribute coding. Attribute coding typically involves the generation of levels of detail (for predicting/lifting transform), or generation RAHT tree (for RAHT transform), and both these methods make use of the geometry. When spherical coordinate conversion is not used, the geometry represented in Cartesian coordinates is used for attribute coding; a Morton scan order is chosen for parsing the points. For sparse data, such as those obtained using LIDAR sensors, using the Cartesian coordinates results in sub-optimal relationship of points in the Morton order. As the spherical coordinate system uses the sensor scan characteristics, geometry converted to the spherical coordinate system provides a much more efficient representation of the points. Morton scan order in this domain provides more meaningful relationship of points, and this improves the efficiency of coding attributes. Typically, spherical coordinate conversion is used only when the angular mode (used to code the geometry) is enabled.

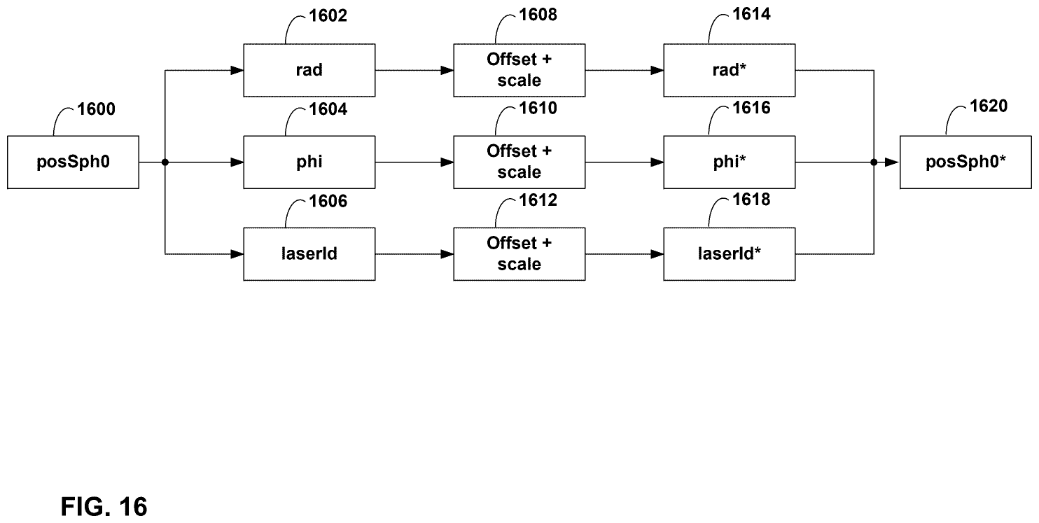

The spherical coordinate representation that is used is for attribute coding (posSph0*) is obtained by applying an offset and scale to the actual spherical coordinate representation of the geometry (posSph0), as applying offset/scale is a linear transformation. FIG. 16 illustrates how the radius (rad), azimuth (phi) and laser ID (laserId) that together form the spherical representation posSph0 are transformed to rad*, phi* and laserId* of the spherical representation posSph0* that is used for attribute prediction. The offset and scale values for each dimension is signaled in the attribute parameter set (APS).

For example, in FIG. 16, reference point cloud frame (posSph0) 1600 is in spherical coordinates and includes radius (rad) component 1602, azimuth (phi) component 1604, and laser identification (laserId) component 1606. Reference point cloud frame 1600 may be used to refer to the coordinate representation of the geometry of the reference point cloud frame 1600. Each of rad 1602, phi 1604, and laserID 1606 may go through an offset and scale process 1608, 1610, and 1612, respectively. The result may be a processed frame (posSph0*) 1620 having radius (rad*) component 1614, azimuth (phi*) component 1616, and laser identification (laserId*) component 1618. In one or more examples, posSph0* may be used for intra-prediction of attribute data of points in the reference frame, but another processed frame may be used for inter-prediction of attribute date of points in a current frame.

The following describes examples of inter-prediction buffers. Some example techniques use the same reference frame buffer for the inter prediction of geometry and inter prediction of attributes.

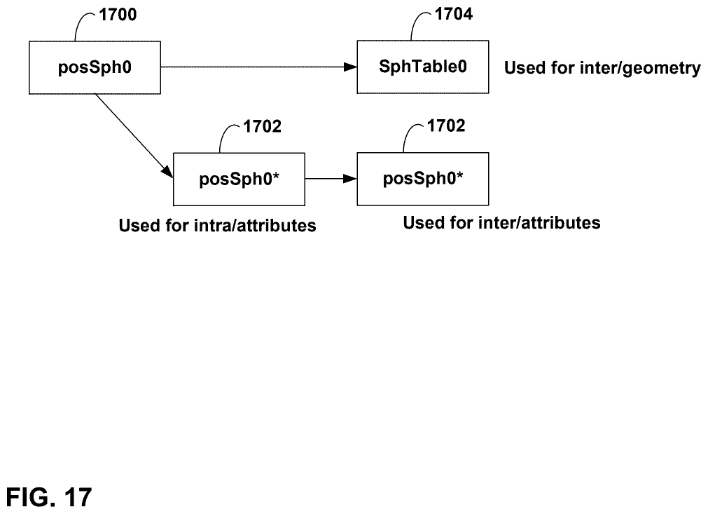

For example, consider a reference frame 0. The reconstructed spherical coordinates of frame 0, posSph0 1700 is used to generate posSph0* 1702 using spherical coordinate conversion, as described above with respect to FIG. 16. In some techniques, this representation, posSph0* is used both for intra attribute prediction and inter attribute prediction, as illustrated in FIG. 17. That is, posSph0* 1702 is used both for intra-prediction encoding and decoding attribute data of points of the reference point cloud frame (e.g., reference frame 0), and inter-prediction encoding and decoding attribute data of points of the current point cloud frame. As described in more detail, this may be inefficient from memory storage perspective, as posSph0* 1702 is retained frame-to-frame (e.g., kept in storage after completion of encoding or decoding reference frame 0 to the start of encoding or decoding the current frame).

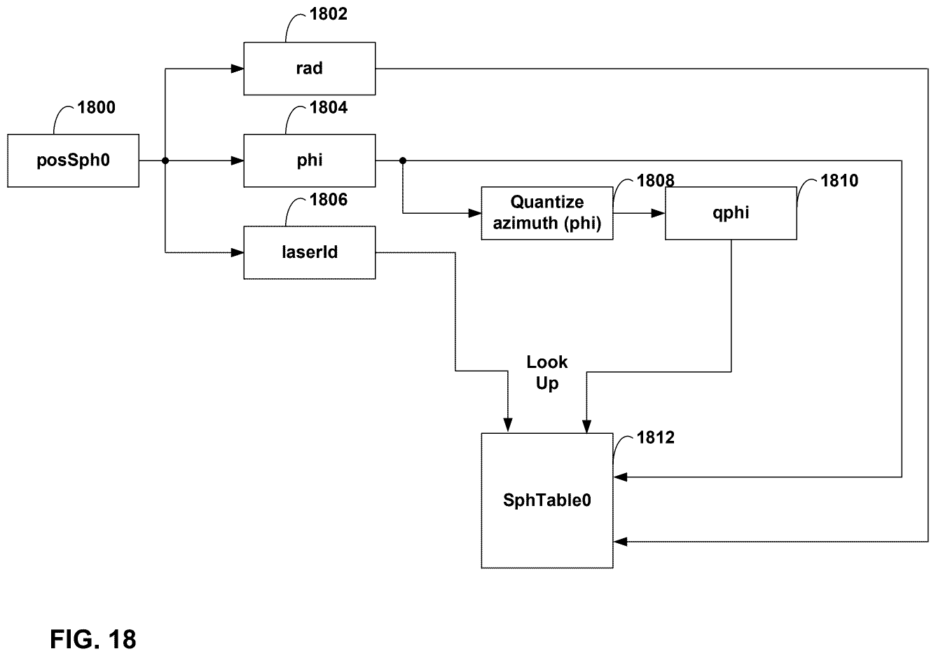

In parallel, posSph0 is also used to generate a spherical table SphTable0 that is used for inter-prediction of geometry by the following method illustrated in FIG. 18. A quantized azimuth qPhi and laserID are used as lookup values in a spherical table that stores the points in the spherical coordinates. The spherical representation may then be used to derive scaled presentation posSph0*x partly using spherical coordinate conversion.

SphTable0 1704 may be considered as a first level processed frame. For instance, G-PCC encoder 200 and G-PCC decoder 300 may apply a first process to a reference point cloud frame (e.g., posSph0 1700) to generate a first level processed frame (e.g., SphTable0 1704). One example of the first process is illustrated in FIG. 18.

For example, in FIG. 18, G-PCC encoder 200 and G-PCC decoder 300 may apply a first process to a reference point cloud frame (posSph0) 1800 to generate a first level processed frame (SphTable0) 1812. For instance, the reference point cloud frame 1800 may include radius (rad) component 1802, azimuth (phi) component 1804, and laser identification (laserId) component 1806. G-PCC encoder 200 and G-PCC decoder 300 may quantize (1808) the azimuth component 1804 to generated quantized azimuth component 1810.

For each of a plurality of quantized azimuth components 1810 and a for a laser identification component 1806, G-PCC encoder 200 and G-PCC decoder 300 may store a radius component 1802 and an azimuth component 1804 for “k” number of points of the reference point cloud frame 1800 associated with the laser identification component 1806 to generate SphTable0 1812. As illustrated, a quantized azimuth qPhi 1810 and laserID component 1806 are used as lookup values in a spherical table (SphTable0 1812) that stores the points in the spherical coordinates. That is, each of the plurality of quantized azimuth components 1810 is an index to the table (SphTable0 1812), along with the laser identification component 1806, and the table (SphTable0 1812) is at least a portion of the first level processed frame.

In addition, for each entry in the spherical table (indexed by a laser ID and quantized azimuth value), support of multiple points was added. Only the first point in each entry may be available for geometry inter prediction, but the other points may be available for attribute inter prediction. For example, when points are added to the spherical table, multiple points in the reference frame may have the same quantized azimuth value and laser ID. A maxPointsPerEntryMinus1 syntax element provides a maximum number of points that may be added per entry of the spherical table. Until the maxPointsPerENtryMinus1+1 entries are not filled, points with same quantized azimuth and laser ID value are added to the entry.

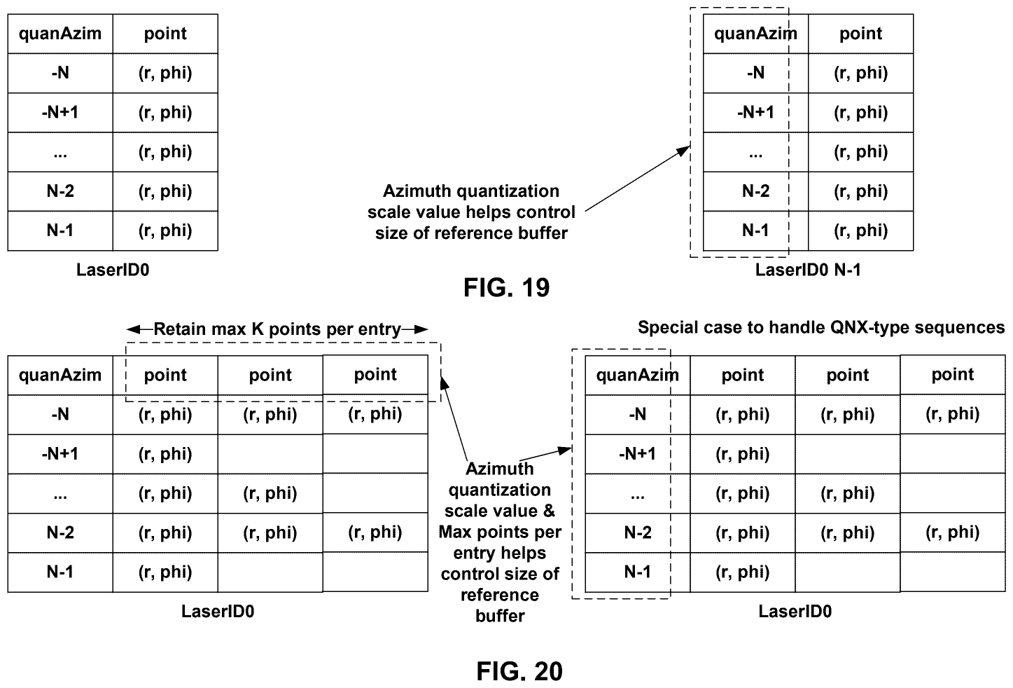

FIG. 19 is a conceptual diagram illustrating an example of a spherical table with only one point per entry. FIG. 20 is a conceptual diagram illustrating an example of a spherical table with multiple (maximum K) points per entry. That is, FIG. 20 illustrates an example of the spherical table with multiple points per entry. For ease, for each, the table associate with laser ID is depicted separately but may be considered as a spherical table.

The following describes some example techniques. The example techniques may be applied independently or in a combined way.

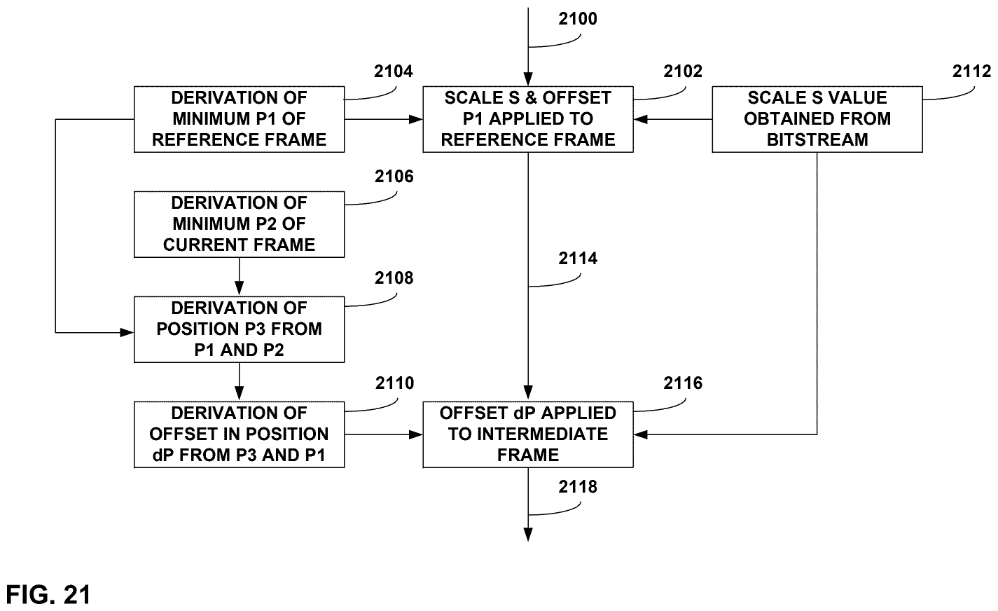

One issue with some techniques may be that such techniques use two stages for applying scale and offset to reference frames to generate the updated reference frame for the attribute inter prediction case. This is illustrated in FIG. 21.

In FIG. 21, reference frame R_orig 2100 contains positions and attributes is a previously decoded frame which will be (eventually) used to derive a reference frame (e.g., to generate an updated reference frame) for attribute inter prediction of the current frame. When spherical coordinate conversion is enabled, a scale and offset is applied to the positions of the current frame.

In attribute inter prediction, G-PCC encoder 200 and G-PCC decoder 300 may apply the scale and offset to the reference frame 2100 (2102). In FIG. 21, the offset applied is derived as a minimum position P1 that is derived for the reference frame R_orig (this could be taken as a vector with each element being the minimum value of the position of the points in the reference frame in that corresponding dimension). For example, G-PCC encoder 200 and G-PCC decoder 300 may determine respective spherical coordinate minimum values in the reference frame, referred to as P1 (2104). As one example, G-PCC encoder 200 and G-PCC decoder 300 may determine a first radius minimum value, referred to as P1[0], that is a minimum among radius coordinates of the points in the reference frame, determine a first azimuth minimum value, referred to as P1[1], that is a minimum among azimuth coordinates of the points in the reference frame, and determine a first laser identification minimum value, referred to as P1[2], that is a minimum among laser identification coordinates of the points in the reference frame.

When the scale and offset are applied, the scaled reference frame R_scaled, also called an intermediate reference frame, is obtained as shown above. That is, G-PCC encoder 200 may signal respective scale values, S[0], S[1], and S[2], and G-PCC decoder 300 may parse the respective scale values from the bitstream (2112).

G-PCC encoder 200 and G-PCC decoder 300 may apply the respective scale (e.g., S[0], S[1], and S[2]) and offset values (e.g., P1[0], P1[1], and P [2]) to respective coordinates of points in reference frame 2100 to generate intermediate frame 2114, also called scaled frame 2114 as shown below (2102).

For example, a position P_scaled, also called P_intermediate, in the frame R_scaled, also called R_intermediate, may be derived from a point P_orig in the frame R_orig 2100 as follows (indices 0, 1, 2 indicate the three dimensions of the positions in the point cloud):

$$P\_intermediate [ 0 ] = ( P\_orig [ 0 ] - P 1 [ 0 ] ) * S [ 0 ]$$

$$P\_intermediate [ 1 ] = ( P\_orig [ 1 ] - P 1 [ 1 ] ) * S [ 1 ]$$

$$P\_intermediate [ 2 ] = ( P\_orig [ 2 ] - P 1 [ 2 ] ) * S [ 2 ]$$

The above application of scaling and offset may be only a general representation of derivation of P_intermediate from P_orig, and the issue of two stages for scale and offset may apply to other forms of derivation of P_intermediate from P_orig. As an example, the issue may be present where the scale value may be signaled with a precision of k bits, and then the derivation may be as follows:

$$P\_intermediate [ i ] = ( ( P\_orig [ i ] - P 1 [ i ] ) * S [ i ] ) + ( 1 << ( k - 1 ) ) >> k$$

In some cases, rounding offsets 1<<(k−1) may not be applied, and in some cases, the scale may be a power of two and hence implemented using shifts. The disclosed methods apply to various methods application of scale-offset for spherical coordinate conversion, including where scale may not be a power of two and where rounding offsets may or may not be applied.

G-PCC encoder 200 and G-PCC decoder 300 may also derive minimum P2 of the current frame (2106). For example, G-PCC encoder 200 and G-PCC decoder 300 may determine respective spherical coordinate minimum values in the current frame, referred to as P2 (2106). As one example, G-PCC encoder 200 and G-PCC decoder 300 may determine a second radius minimum value, referred to as P2[0], that is a minimum among radius coordinates of the points in the current frame, determine a second azimuth minimum value, referred to as P2[1], that is a minimum among azimuth coordinates of the points in the current frame, and determine a second laser identification minimum value, referred to as P2[2], that is a minimum among laser identification coordinates of the points in the current frame.

When the minimum position P2 of the current frame is derived (which may be used for the spherical coordinate conversion of the current frame), the value of P2 may not be the same as P1. Using different values of offsets may result in inefficient prediction, as the positions of the current frame and the reference frame may not be aligned. Therefore, G-PCC encoder 200 and G-PCC decoder 300 may determine a position P3 from positions P1 and P2 (2108). The value of P3 may be typically obtained by taking the minimum of the respective coordinates of P1 and P2. That is, P3 is derived as:

$$P 2 [ 0 ] = min ( P 1 [ 0 ] , P 2 [ 0 ] )$$

$$P 3 [ 1 ] = min ( P 1 [ 1 ] , P 2 [ 1 ] )$$

$$P 3 [ 2 ] = min ( P 1 [ 2 ] , P 2 [ 2 ] )$$

G-PCC encoder 200 and G-PCC decoder may determine an offset position dP from P3 and P1 (2110). The dP may denote the difference in the positions P1 and P3, and is derived from P3 and P1 as follows:

$$dP [ 0 ] = P 3 [ 0 ] - P 1 [ 0 ]$$

$$dP [ 1 ] = P 3 [ 1 ] - P 1 [ 1 ]$$

$$dP [ 2 ] = P 3 [ 2 ] - P 1 [ 2 ]$$

G-PCC encoder 200 and G-PCC decoder 300 may generate the updated reference frame 2118 that is used for inter-prediction of attribute data by applying dP to the intermediate frame 2114 (2116). For example, the final reference frame 2118 that is used for attribute inter prediction is obtained by applying the offset dP on the scaled reference frame (referred to as offset adjustment). In this stage, the scale values are applied to the offset dP and then added to the intermediate reference frame positions to obtain the final reference frame.

$$P\_updated [ 0 ] = P\_intermediate [ 0 ] - dP [ 0 ] * S [ 0 ]$$

$$P\_updated [ 1 ] = P\_intermediate [ 1 ] - dP [ 1 ] * S [ 1 ]$$

$$P\_updated [ 2 ] = P\_intermediate [ 2 ] - dP [ 2 ] * S [ 2 ]$$

In some alternatives, the offset adjustment may be performed with negative dP instead of dP. In some examples, the above operations may only apply to the positions of the reference frame. The corresponding attribute value at each position may be carried over with each operation.

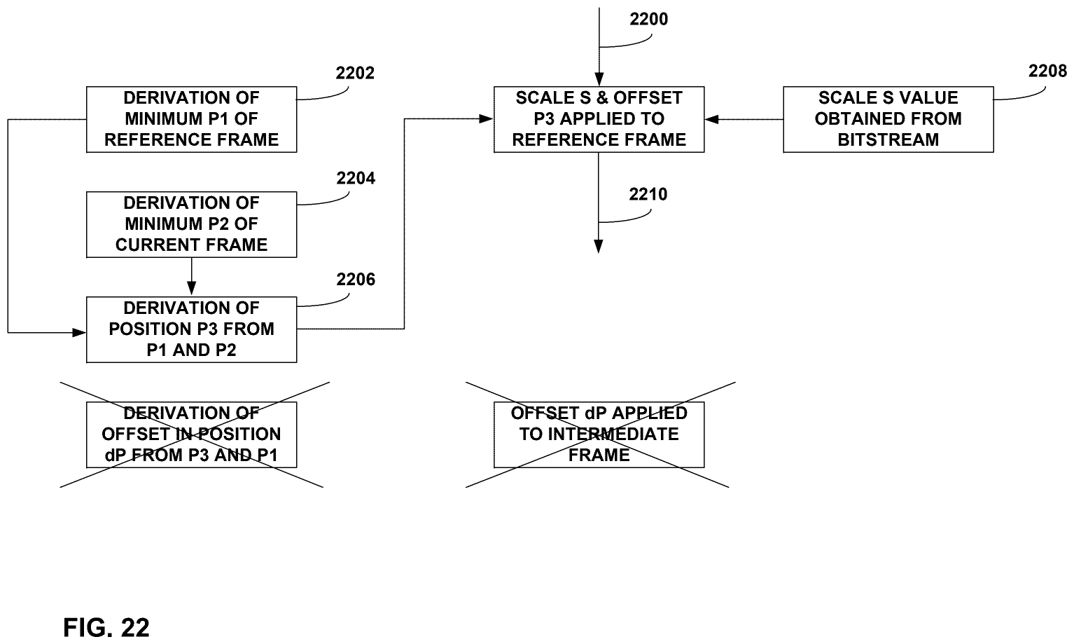

In accordance with one or more examples described in this disclosure, instead of applying the spherical coordinate conversion scale and offset to the reference frame in two stages, a single stage is used to apply the spherical coordinate conversion (as shown in FIG. 22).

For example, similar to above, G-PCC encoder 200 may signal respective scale values, S[0], S[1], and S[2], and G-PCC decoder 300 may parse the respective scale values from the bitstream (2208). Also, G-PCC encoder 200 and G-PCC decoder 300 may determine respective spherical coordinate minimum values in the reference frame, referred to as P1 (2202). As one example, G-PCC encoder 200 and G-PCC decoder 300 may determine a first radius minimum value, referred to as P1[0], that is a minimum among radius coordinates of the points in the reference frame, determine a first azimuth minimum value, referred to as P1[1], that is a minimum among azimuth coordinates of the points in the reference frame, and determine a first laser identification minimum value, referred to as P1[2], that is a minimum among laser identification coordinates of the points in the reference frame.

G-PCC encoder 200 and G-PCC decoder 300 may also derive minimum P2 of the current frame (2204). For example, G-PCC encoder 200 and G-PCC decoder 300 may determine respective spherical coordinate minimum values in the current frame, referred to as P2 (2204). As one example, G-PCC encoder 200 and G-PCC decoder 300 may determine a second radius minimum value, referred to as P2[0], that is a minimum among radius coordinates of the points in the current frame, determine a second azimuth minimum value, referred to as P2[1], that is a minimum among azimuth coordinates of the points in the current frame, and determine a second laser identification minimum value, referred to as P2[2], that is a minimum among laser identification coordinates of the points in the current frame.

G-PCC encoder 200 and G-PCC decoder 300 may determine respective spherical coordinate offsets, referred to as P3, based on the respective spherical coordinate minimum values in the reference frame and the respective spherical coordinate minimum values in the current frame (2206). For example, similar to above:

$$P 3 [ 0 ] = min ( P 1 [ 0 ] , P 2 [ 0 ] )$$

$$P 3 [ 1 ] = min ( P 1 [ 1 ] , P 2 [ 1 ] )$$

$$P 3 [ 2 ] = min ( P 1 [ 2 ] , P 2 [ 2 ] ) .$$

In the above example, P3[0] may be considered as a radius offset that is based on a minimum between the first radius minimum value P1[0] and the second radius minimum value P2[0]. P3[1] may be considered as an azimuth offset that is based on a minimum between the first azimuth minimum value P1[1] and the second azimuth minimum value P2[1]. P3[2] may be considered as a laser identification offset that is based on a minimum between the first laser identification minimum value P1[2] and the second laser identification minimum value P2[2].

In one or more examples, G-PCC encoder 200 and G-PCC decoder 300 may apply the respective spherical coordinate offsets to respective spherical coordinates of points in the reference frame 2200. G-PCC encoder 200 and G-PCC decoder may scale, with respective scale factors, the result of applying the respective spherical coordinate offsets to the respective spherical coordinates of points in the reference frame to generate the updated reference frame 2210.

For example, for each point in the reference frame, G-PCC encoder 200 and G-PCC decoder 300 may subtract the radius offset from a radius coordinate of a respective point in the reference frame 2200 to generate a radius offset value for the respective point. G-PCC encoder 200 and G-PCC decoder 300 may subtract the azimuth offset from an azimuth coordinate of the respective point in the reference frame 2200 to generate an azimuth offset value for the respective point. G-PCC encoder 200 and G-PCC decoder 300 may subtract the laser identification offset from a laser identification coordinate of a respective point in the reference frame to generate a laser identification offset value for the respective point.

To scale, with respective scale factors, the result of applying the respective spherical coordinate offsets to the respective spherical coordinates of points in the reference frame 2200 to generate the updated reference frame 2210, G-PCC encoder 200 and G-PCC decoder may scaling, with a first scale factor S[0], the radius offset value for the respective point to generate a radius coordinate for an updated point in the updated reference frame 2210. G-PCC encoder 200 and G-PCC decoder 300 may scale, with a second scale factor S[1], the azimuth offset value for the respective point to generate an azimuth coordinate for the updated point in the updated reference frame. G-PCC encoder 200 and G-PCC decoder 300 may scale, with a third scale factor S[2], the laser identification offset value for the respective point to generate a laser identification coordinate for the updated point in the updated reference frame 2210.

That is, the G-PCC encoder 200 and G-PCC decoder 300 may determine coordinates for a point in updated reference frame 2210 by performing the following:
P_updated[0]=(P_orig[0]-P3[0])*S[0], where P_updated[0] is the radius coordinate, (P_orig[0]-P3[0]) is the radius offset value for the respective point, and S[0] is a first scale factor for the radius coordinate
P_updated[1]=(P_orig[1]-P3[1])*S[1], where P_updated[1] is the azimuth coordinate, (P_orig[1]-P3[1]) is the azimuth offset value for the respective point, and S[1] is a second scale factor for the azimuth coordinate
P_updated[2]=(P_orig[2]-P3[2])*S[2], where P_updated[2] is the laser identification coordinate, (P_orig[2]-P3[2]) is the laser identification offset value for the respective point, and S[2] is a third scale factor for the laser identification coordinate.

That is, in accordance with examples described in this disclosure, instead of using the position P1 in the first stage, and then using dP (derived from P3) in the second stage, the position P3 is directly used to derive the second reference frame (i.e., updated reference frame 2210) that is used for attribute inter prediction. The strike marks in FIG. 22 indicate processes that are skipped using techniques described in this disclosure, thus resulting in reduced codec complexity (runtime—derivation of dP and second stage of offset is skipped, memory—dP need not be stored). For example, as shown in FIG. 22, derivation of offset in position dP from P3 and P1 may be removed, and offset dP applied to reference frame may be removed.

In one or more examples, generating updated reference frame 2118 (FIG. 21) and generating updated reference frame 2210 (FIG. 22) may not result in the same updated reference frame. In some examples, generating intermediate frame 2114 may include non-reversible operations, such as rounding or quantization. Therefore, updated reference frame 2118, that is generated from intermediate frame 2114, is generated with values that have been rounded or quantized. In some examples, updated reference frame 2210 may be generated directly from samples in reference frame 2200. Therefore, there may not be rounding or quantizing. Accordingly, in some examples, updated reference frame 2118 (FIG. 21) and updated reference frame 2210 (FIG. 22) may be different.

However, it may be possible that some rounding or quantization is applied to samples in reference frame 2200 before the scaling or offset, or it may be possible that rounding and quantization is skipped for generating updated reference frame 2118. That is, it may be possible that updated reference frame 2210 and updated reference frame 2118 are the same or substantially similar. Even for such cases, and generally in accordance with one or more examples, updated reference frame 2210 (FIG. 22) may be generated in single stage which may result in reduced memory utilization and reduced latency as compared to the multi-stage technique for generating updated reference frame 2118 (FIG. 21).

In some cases, except the derivation of scale S, all other processes are applied at G-PCC encoder 200 and G-PCC decoder 300. In the encoder, scale S may be derived based on the histogram/statistics of the point positions and encoded in the bitstream; S is typically the same for the current and reference frame. At the decoder, the scale S may be obtained by parsing the bitstream (e.g., syntax elements signaled in a parameter set such as SPS, GPS, APS or the geometry/attribute data units). The above techniques for deriving S is one example, and in some cases, G-PCC encoder 200 and G-PCC decoder 300 may also derive S using the same techniques.

There may be issues with lack of offset adjustment for predicting and lifting transforms. As described above, differences in the minimum position derived for the current frame and the reference frame may adversely affect the efficiency of inter prediction. In the current G-PCC specification/software, offset adjustment is only performed for the attribute inter prediction when the attributes are coded with RAHT. It is not applied when the attributes are coded using predicting transform or lifting transform.

In one or more examples, G-PCC encoder 200 and G-PCC decoder 300 may extend the process of offset adjustment to the cases when attributes are coded using predicting transform or lifting transform.

The following describes downsampling on same reflectance. In H. Hur, [G-PCC][EE13.2] Report on inter prediction (Test5), ISO/IEC JTC1/SC29/WG7 m68325, July 2024, and H. Hur, [G-PCC][EE13.2] Report on inter prediction (Test6), ISO/IEC JTC1/SC29/WG7 m68341, July 2024, a downsampling method, referred to as the “downsampling method,” is provided that works when more than one point per entry is allowed in the spherical reference table. This method ensures that when the spherical table is generated, a new point with same reflectance as the last point in the entry is added only when their respective azimuth and radii differ (absolute value of difference) by more than a respective threshold. Otherwise, the reflectance is the same and azimuth and radii are within a threshold difference, and the point is not added. This has the effect of downsampling as some points may not be added to the spherical table and the overall table will have fewer points.

A syntax element dn_sampling_range_plus1 is signalled. When dn_sampling_range_plus1 is 0, value dn_sampling_range is −1 and this effectively disables the downsampling method. When dn_sampling_range_plus1 is greater than zero, the downsampling method is enabled with radius and azimuth thresholds derived as follows:

$$azimThreshold = dn\_sampling \_range$$

$$radThreshold = ( coordScale [ 0 ] >> 8 ) * dn\_sampling \_range$$

where, coordScale[0] corresponds to the scale value used for radius in SCC. The condition for adding the point may be as follows:

$$if ( latest\_pt [ 2 ] == pt [ 2 ] \{$$

$$if ( ( abs ( latest\_pt [ 0 ] - pt [ 0 ] > dnRadiusRange ) ‖ ( abs ( latest\_pt [ 1 ] > dnAzimuthRange ) )$$

$$refPointCurLaser [ phiQ ] . push\_back ( pt ) ;$$

where latest_pt is the last point at the coding instance at that entry, dnRadiusRange and dnAzimuthRange are the radius and azimuth thresholds, pt[0], pt[1] and pt[2] are the radius, azimuth and the reflectance associated with the point that is being tested to be added to the reference frame. refPointCurLaser[layerId] refers to the spherical sub-table with index layer ID and phiQ is the quantized azimuth value.

One potential benefit of the method is to reduce the size of the reference frame buffer (due to downsampling), which in turn reduces the complexity of the codec.

The following relates to the signaling of dn_sampling_range_plus1. One issue may be that the syntax element dn_sampling_range_plus1 is signaled in the GPS independent of the value of the syntax element indicating maximum points per entry (maxPointsPerEntryMinus1). dn_sampling_range_plus1 is only used when maximum points per entry is more than 1. Unnecessary signaling results in signaling inefficiency.

In accordance with one or more examples described in this disclosure, the signaling of dn_sampling_range_plus1 is conditioned on the value of maxPointsPerEntryMinus1. For example, dn_sampling_range_plus1 is only signaled when maxPointsPerEntryMinus1>0 (which is maxPointsPerEntry>1). That is, G-PCC decoder 300 may parse a syntax element (e.g., dn_sampling_range_plus1), used to determine thresholds (e.g., azimThreshold and radThreshold), based on a determination that a maximum number of points that can be added per entry in a spherical table (e.g., SphTable0) used for inter-predicting is greater than one (e.g., maxPointsPerEntry>1). The thresholds may be used to determine whether a first point is to be added in an entry in the spherical table. In one or more examples, a constraint may be added so that when maxPointsPerEntryMinus1 is 0, the value of dn_sampling_range_plus1 will take the value that disables the tool.

The following relates to the use of dn_sampling_range_plus1 for deriving azimuth and radius thresholds. One issue may be that the syntax element dn_sampling_range_plus1 is used to derive thresholds for azimuth difference and radius difference that is used in the downsampling algorithm. The thresholds are currently derived as follows:

$$azimThreshold = dn\_sampling \_range$$

$$radThreshold = ( coordScale [ 0 ] >> 8 ) * dn\_sampling \_range$$

where, coordScale[0] corresponds to the scale value used for radius in SCC. The first issue with this aspect is that the coordScale value is shifted right by a factor of 8 before multiplying with dn_sampling_range; this results in loss of precision of scale value. Moreover, the comparison of azimuth and radius must be performed in similar scales. Using coordScale[ ] only for radius threshold but not for the azimuth threshold results in different scales.

In accordance with one or more examples described in this disclosure, the radius and azimuth thresholds are derived as follows (coordScale applied to both azimuth and radius):

$$azimThreshold = ( coordScale [ 1 ] >> 8 ) * dn\_sampling \_range$$

$$radThreshold = ( coordScale [ 0 ] >> 8 ) * dn\_sampling \_range$$

In one or more examples, the radius and azimuth threshold may be derived as follows (coordScale of azimuth, coordScale[1] also taken into account):

$$azimThreshold = dn\_sampling \_range$$

$$radThreshold = ( coordScale [ 0 ] >> 8 ) / coordScale [ 1 ] * dn\_sampling \_range$$

In one or more examples, the radius and azimuth threshold may be derived as follows (avoid division operation, and instead use an approximation):

$$azimThreshold = dn\_sampling \_range$$

$$radThreshold = DivApprox ( ( coordScale [ 0 ] >> 8 ) , coordScale [ 1 ] ) * dn\_sampling \_range$$

In one or more examples, the right shift is applied after multiplication with the sampling_range (this retains the precision of coordScale). For example,

$$radThreshold = ( coordScale [ 0 ] * dn\_sampling \_range ) >> 8 or ( with rounding )$$

$$radThreshold = ( coordScale [ 0 ] * dn\_sampling \_range ) + ( 1 << 7 ) >> 8$$

The following relates to the relation between the downsampling method and SCC. One issue may be that the radius threshold uses the scale value of SCC. However, the SCC may not be enabled in all cases. In such situations where SCC is disabled, an inefficient radius threshold may be derived which would result in reduced performance, or in worst case the decoder will crash.

Syntax elements associated with SCC are present in the APS, whereas the syntax elements associated with the downsampling method are present in the GPS. The syntax element (dn_sampling_range_plus1) cannot be conditioned on the APS syntax elements as it is desirable to maintain parsing independence between parameter sets.

In accordance with one or more examples described in this disclosure, the techniques may add a constraint to ensure that the downsampling method is enabled only when SCC is enabled. For example, the following constraint could be added: It is a requirement of bitstream conformance that when attr_coord_conv_enabled is 0, dn_sampling_range_plus1 shall be 0.

In one or more examples, instead of deriving the radius threshold using coordScale, the radius threshold may be explicitly signaled, or a second syntax element may be signaled which may be used to derive the radius threshold.

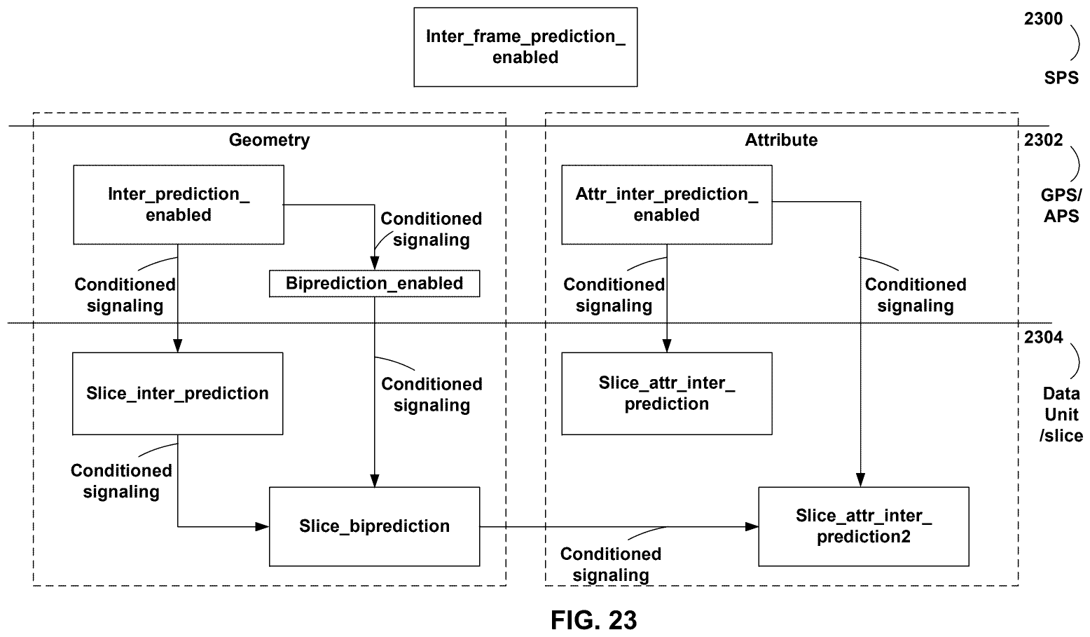

The following relates to the signaling of syntax elements related to inter-prediction. The overall syntax element structure associated with enabling inter prediction (including bi-prediction) for geometry and attributes is illustrated in FIG. 23. The syntax elements are indicated in boxes, and the marking indicate whether they are signaled in the SPS 2300, GPS/APS 2302, or slice level 2304. The solid arrows marked as conditioned signaling indicate that from syntax element A to B the signaling on B is conditioned on the value of A. As an example, signaling of slice_inter_prediction (geometry data unit/slice) is conditioned on the value of the GPS syntax element inter_prediction_enabled; signaling of slice_biprediction is conditioned on the value of GDU syntax element slice_inter_prediction and GPS syntax element biprediction_enabled.

The following is an index to the various syntax elements in FIG. 23:

| | Syntax | |
|---|---|---|
| Syntax element | structure | Description |
| Inter_frame_prediciton_enabled | SPS | Allow inter prediction |
| | | in the frames |
| Inter_predictoin_enabled | GPS | Allow inter prediction |
| | | of positions in the |
| | | point cloud frames |
| Biprediction_enabled | GPS | Allow biprediction of |
| | | positions in the point |
| | | cloud frames |
| Slice_inter_prediction | GDU header | Enabled inter |
| | | prediction of point |
| | | positions in the GDU |
| Slice_biprediction | GDU header | Allow/enable |
| | | biprediction of point |
| | | positions in the GDU |
| Attr_inter_prediction_enabled | APS | Allow inter prediction |
| | | of attributes in the |
| | | point cloud frames |
| Slice_attr_inter_prediction | ADU header | Allow inter prediction |
| | | of attributes in the |
| | | ADU |
| Slice_attr_inter_prediction2 | ADU header | Allow biprediction of |
| | | attributes in the ADU |

In the above, GDU and ADU stand for Geometry and Attribute Data Units, respectively. The above signaling may have several deficiencies that are listed below.

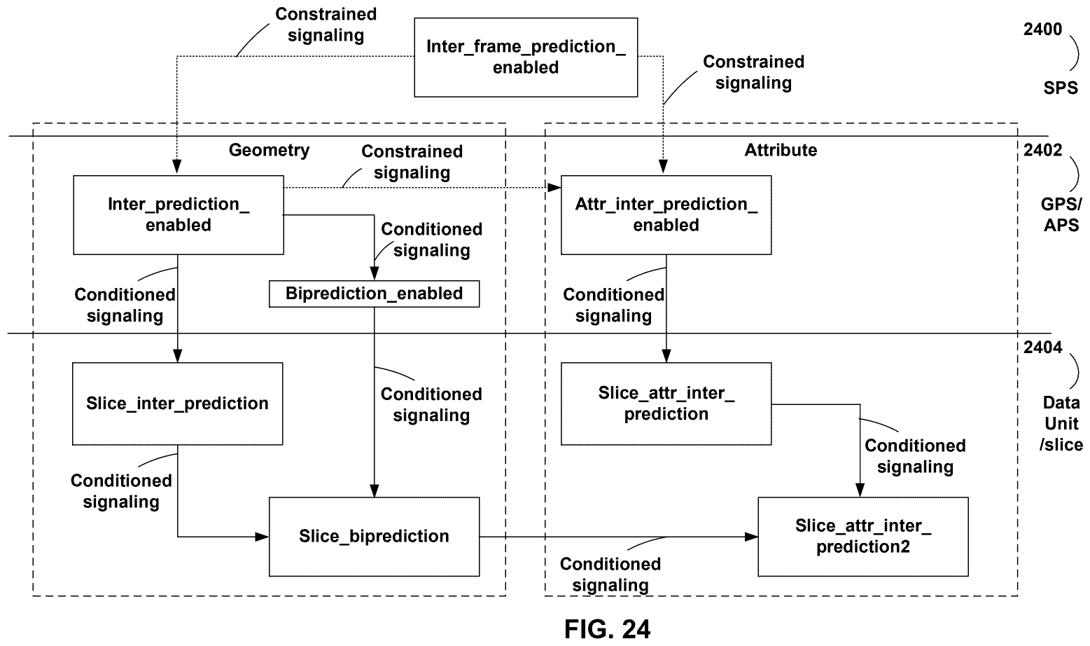

FIG. 24 is a flow diagram illustrating another example syntax element structure associated with enabling inter prediction (including bi-prediction) for geometry and attributes. For instance, FIG. 24 illustrates constraints that may be placed to ensure that there is no interdependency in the different parameter sets, and to ensure that the different parameter sets do not include syntax element values that contradict syntax elements in other parameter sets. FIG. 24 illustrates SPS 2400, GPS/APS 2402, and slice level 2404.

The following relates to the dependence of APS/GPS syntax elements on SPS syntax element. One issue may be that the SPS syntax element inter_frame_enabled_flag specifies whether inter prediction is used at all for coding the point cloud frames. However, the GPS and APS syntax elements inter_prediction_enabled and attr_inter_prediction_enabled, respectively, that specify usage of inter prediction in geometry and attribute data units can take any value independent of inter_frame_enabled_flag, which may lead to indication of contradictory values.

It may not be desirable to condition the signaling of GPS and APS syntax elements on the SPS as this would introduce parsing dependence between the parameter sets.

In accordance with one or more examples described in this disclosure, the techniques may include adding a constraint that ensures that the GPS and APS syntax elements associated with inter prediction do not contradict the SPS syntax element inter_frame_enabled_flag. For example, the following constraints may be added: It is a requirement of bitstream conformance that when inter_frame_enabled_flag is 0, inter_prediction_enabled and attr_inter_prediction_enabled shall both be 0. This constraint is shown with constrained signaling from inter_frame_prediction_enabled in FIG. 24.

The following relates to dependence of APS syntax element on GPS syntax element. One issue may be that the design of G-PCC codec is such that the coding of attributes is dependent on the geometry. Therefore, when inter prediction is disabled for geometry, inter prediction may be enabled for attributes. However, such a combination is currently allowed in the syntax. Moreover, several steps in the decoding process for attribute inter prediction assume that geometry inter prediction is enabled.

In accordance with one or more examples described in this disclosure, the techniques may include adding a constraint that ensures that when inter prediction is disabled for geometry, it is also disabled for attributes. For example, the following constraint may be added: It is a requirement of bitstream conformance that when inter_prediction_enabled is 0, attr_inter_prediction_enabled shall be 0. This constraint is shown with constrained signaling from inter_prediction_enabled to attr_inter_predication_enabled in FIG. 24.

The following relates to signaling of slice attr biprediction flag (noted as Aspect 4.3). One issue may be that the signaling of slice_attr_inter_prediction2 (which enables biprediction at the slice level) is conditioned on the APS syntax element attr_inter_prediction_enabled and slice_biprediction. When attr_inter_prediction_enabled is 1, it is possible that the slice_attr_inter_prediction may be 0 which indicates that attribute inter prediction is not to be applied to the current slice. However, in the current signaling, it is possible to signal slice_attr_inter_prediction2 to be 1 even when slice_attr_inter_prediction is 0, which may result in a decoder crash.

| if(attr_inter_prediction_enabled){ | | |
|---|---|---|
| slice_attr_inter_prediction | u(1) | 7.4.4.2 |
| if(slice_biprediction) | | |
| slice_attr_inter_prediction2 | u(1) | 7.4.4.2 |

In accordance with one or more examples, the signaling of syntax element that enables biprediction for attributes at the slice level should be additionally conditioned on the value of syntax element that enables inter prediction of attributes at the slice level. This is shown with the conditioned signaling from slice_attr_inter_prediction to slice_attr_inter_prediction2 in FIG. 24. For example, the syntax table may be updated as follows, where the addition is shown between /ADD and ADD/:

| if(attr_inter_prediction_enabled){ | | |
|---|---|---|
| slice_attr_inter_prediction | u(1) | 7.4.4.2 |
| if(slice_biprediction /ADD && slice_attr_inter_prediction | | |
| ADD/) | | |
| slice_attr_inter_prediction2 | u(1) | 7.4.4.2 |

The following describes an overall syntax structure including aspects described above. An illustration of the syntax structure along with the above techniques is presented in FIG. 24. In addition to the arrows marked as conditioned signaling (explained earlier), dotted arrows are added. A dotted arrow from syntax A to B shows that the value of syntax element B is constrained based on the value of syntax element A. The various aspects noted above are shown in FIG. 24. It should be understood that not all of are needed (e.g., not all of the constraints and conditioned signaling may be needed), and any subset or combination of such aspects may be included in the syntax structure.

The following relates to re-ordering syntax elements in the GDU header. One issue may be that, currently, the inter prediction parameters for inter prediction and biprediction in the GDU header are interleaved affecting readability of the spec. Moreover, several syntax elements are repeated with just a different suffix to indicate applicability to biprediction. Interleaving the syntax elements of regular inter prediction and biprediction has an added disadvantage: for cases/profiles where biprediction is disabled, the decoder will have to parse multiple conditions involving biprediction flag to determine the absence of syntax elements.

| | | |
|---|---|---|
| if(inter_prediction_enabled) { | | |
| slice_inter_prediction | u(1) | 7.4.3.2 |
| if(slice_inter_prediction && biprediction_enabled) | | |
| slice_biprediction | u(1) | 7.4.3.2 |
| if(slice_inter_prediction && global_motion_enabled) { | | |
| if(geom_tree_type == 1){ | | |
| slice_inter_frame_ref_gmc | u(1) | 7.4.3.2 |
| if(slice_biprediction) | | |
| slice_inter_frame_ref_gmc2 | u(1) | 7.4.3.2 |
| } | | |
| if(geom_tree_type == 0 ∥ slice_inter_frame_ref_gmc) | | |
| { | | |
| for(i = 0; i < 3; i++) | | |
| for(j = 0; j < 3; j++) | | |
| gm_matrix[i][j] | se(v) | 7.4.3.2 |
| for(j = 0; j < 3; j++) | | |
| gm_trans[j] | se(v) | 7.4.3.2 |
| } | | |
| if((geom_tree_type == 0 && slice_biprediction) ∥ | | |
| slice_inter_frame_ref_gmc2) { | | |
| for(i = 0; i < 3; i++) | | |
| for(j = 0; j < 3; j++) | | |
| gm_matrix2[i][j] | se(v) | 7.4.3.2 |
| for(j = 0; j < 3; j++) | | |
| gm_trans2[j] | se(v) | 7.4.3.2 |
| } | | |
| if(geom_tree_type == 0) { | | |
| motion_partition_type | u(1) | 7.4.3.2 |
| motion_zero_origin_flag | u(1) | 7.4.3.2 |
| if(motion_partition_type == 1) | | |
| for(k = 0; k < 3; k++) | | |
| motion_block_size[k] | ue(v) | 7.4.3.2 |
| } | | |
| if(geom_tree_type == 1 ∥ motion_partition_type == 0) | | |
| { | | |
| if(geom_tree_type == 0 ∥ slice_inter_frame_ref_gmc) | | |
| { | | |
| gm_thres_top | se(v) | 7.4.3.2 |
| gm_thres_bot | se(v) | 7.4.3.2 |
| } | | |
| if((geom_tree_type == 0 && slice_biprediction) ∥ | | |
| slice_inter_frame_ref_gmc2) { | | |
| gm_thres_top2 | se(v) | 7.4.3.2 |
| gm_thres_bot2 | se(v) | 7.4.3.2 |
| } | | |
| } | | |
| } | | |

In accordance with one or more examples, a syntax structure may be included specifying inter prediction syntax elements with the global motion parameters defined in a new structure, and the parameters specific to biprediction separated.

| | | |
|---|---|---|
| if(inter_prediction_enabled) { | | |
| slice_inter_prediction | u(1) | 7.4.3.2 |
| if(slice_inter_prediction) { | | |
| if(global_motion_enabled) | | |
| global_motion_params(0) | | |
| slice_biprediction | u(1) | 7.4.3.2 |
| if(slice_biprediction && global_motion_enabled ) { | | |
| global_motion_params(1) | | |
| } | | |
| } | | |

| | | |
|---|---|---|
| global_motion_params(idx) { | | |
| slice_inter_frame_ref_gmc[idx] | u(1) | 7.4.3.2 |
| if(geom_tree_type == 0 ∥ slice_inter_frame_ref_gmc[idx]) { | | |
| for(i = 0; i < 3; i++) | | |
| for(j = 0; j < 3; j++) | | |
| gm_matrix[idx][i][j] | se(v) | 7.4.3.2 |
| for(j = 0; j < 3; j++) | | |
| gm_trans[idx][j] | se(v) | 7.4.3.2 |
| } | | |
| if(geom_tree_type == 0 && idx == 0) { | | |
| motion_partition_type | u(1) | 7.4.3.2 |
| motion_zero_origin_flag | u(1) | 7.4.3.2 |
| if(motion_partition_type == 1) | | |
| for(k = 0; k < 3; k++) | | |
| motion_block_size[k] | ue(v) | 7.4.3.2 |
| } | | |
| if(geom_tree_type == 1 ∥ motion_partition_type == 0) | | |
| if(geom_tree_type == 0 ∥ slice_inter_frame_ref_gmc[idx]) { | | |
| gm_thres_top[idx] | se(v) | 7.4.3.2 |
| gm_thres_bot[idx] | se(v) | 7.4.3.2 |
| } | | |
| } | | |

The following describes aspects related to signaling of RAHT prediction modes. One issue may be that RAHT layers are coded using intra prediction, inter prediction or no prediction, indicated by a mode. The RAHT prediction mode is signaled as a context coded element, and two contexts are used. For intra-coded attribute data units (ADU), the context states are reset at the beginning of each ADU. However, for inter-coded ADUs, the context states are not reset. This introduces parsing dependence between ADUs which is not desirable.

Moreover, some techniques support the continuation of context states within slices of a frame that are not the first slice (entropy continuation) or for the first slice of an inter-coded frame (inter entropy continuation). Some techniques of prediction mode signaling do not use this mechanism thereby violating the entropy continuation mechanism.

In accordance with one or more examples, the example techniques may use the context mechanism used for other attribute-related contexts, so that parsing dependence between ADUs is only introduced under entropy continuation/inter entropy continuation. That is, in one or more examples, the techniques may reset mode context variables unless slice_entropy_continuation is equal to 1 or slice_inter_entropy_continuation is equal to 1.

Also, the prediction modes for RAHT may be signaled once per RAHT layer, and there are at most couple of dozen RAHT layers in a slice, in accordance with one or more examples. Context coding for these modes introduces complexity that may not be useful, and bypass coding should be sufficient without impact on coding efficiency. However, context coding may still be used in other examples.

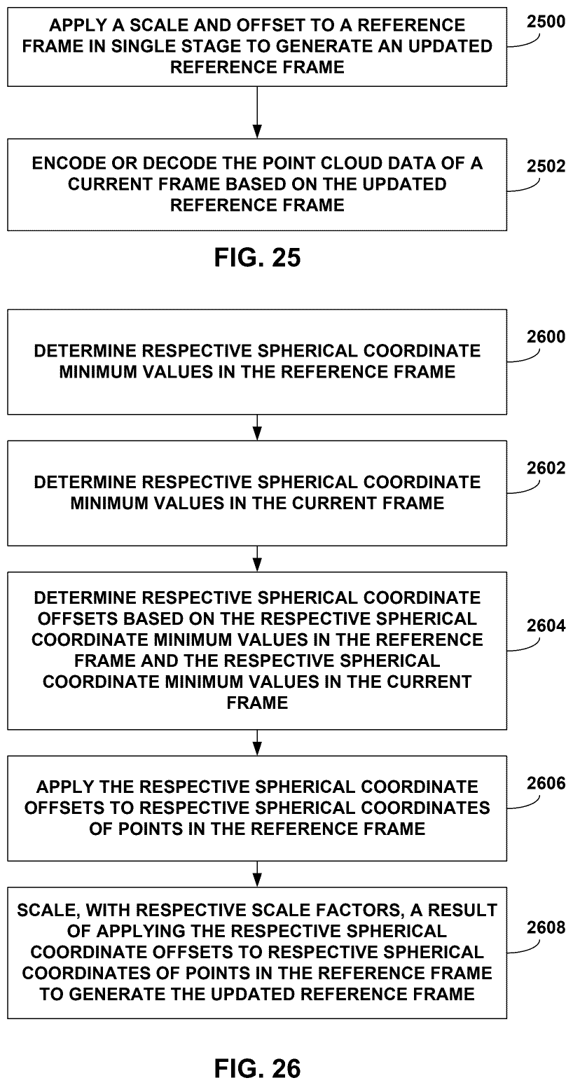

FIG. 25 is a flowchart illustrating an example method of operation. The example techniques are described with respect to processing circuitry, examples of which include processing circuitry of G-PCC encoder 200 or G-PCC decoder 300. Reference is also made to FIGS. 21 and 22.

The processing circuitry may apply a scale and offset to a reference frame 2100 in a single stage to generate an updated reference frame 2210 (2500). For example, to apply the scale and offset to the reference frame 2200 in the single stage, the processing circuitry may apply the scale and offset to the reference frame 2200 without generating an intermediate reference frame 2114 that is generated at least in part by subtracting respective spherical coordinate minimum values from respective spherical coordinates of points in the reference frame 2100. That is, the derivation of offset in position dP from P3 and P1 and applying of the dP offset to intermediate reference frame 2114 may not be needed.

In one or more examples, generating updated reference frame 2118 (FIG. 21) and generating updated reference frame 2210 (FIG. 22) may not result in the same updated reference frame. That is, updated reference frame 2118 (FIG. 21) and updated reference frame 2210 (FIG. 22) may be different. Because reference frame 2118 is generated with intermediate frame 2114, and generating of intermediate frame 2114 may include non-reversible operations, such as rounding or quantization, updated reference frame 2118 may be different from updated reference frame 2210. However, it may be possible for updated reference frame 2118 and updated reference frame 2210 to be the same or substantially the same. Even in such cases, the single stage generation of updated reference frame 2210 may provide reduced memory utilization and reduced latency benefits relative to generating updated reference frame 2118 that require multi-stages.

The processing circuitry may encode or decode the point cloud data of a current frame based on the updated reference frame 2210 (2502). For example, the processing circuitry of G-PCC encoder 200 may signal and the processing circuitry of G-PCC decoder 300 may receive residual information indicative of a difference between attribute data of points in the current frame and attribute data of points in the updated reference frame 2210. The processing circuitry of G-PCC decoder 300 may reconstruct the attribute data of the current frame based on the residual information.

FIG. 26 is another flowchart illustrating an example method of operation. For example, to apply the scale and offset to the reference frame in the single stage, the processing circuitry of G-PCC encoder 200 and G-PCC decoder 300 may determine respective spherical coordinate minimum values, P1, in the reference frame 2200 (2600). The spherical coordinates include a radius coordinate, an azimuth coordinate, and laser identification coordinate. The processing circuitry may determine a first radius minimum value (P1[0]) that is a minimum among radius coordinates of the points in the reference frame 2200, determine a first azimuth minimum value (P1[1]) that is a minimum among azimuth coordinates of the points in the reference frame 2200, and determine a first laser identification minimum value (P1[2]) that is a minimum among laser identification coordinates of the points in the reference frame 2200.

The processing circuitry of G-PCC encoder 200 and G-PCC decoder 300 may determine respective spherical coordinate minimum values, P2, in the current frame (2602). The processing circuitry may determine a second radius minimum value (P2[0]) that is a minimum among radius coordinates of points in the current frame, determine a second azimuth minimum value (P2[1]) that is a minimum among azimuth coordinates of the points in the current frame, and determine a second laser identification minimum value (P2[2]) that is a minimum among laser identification coordinates of the points in the current frame.

The processing circuitry of G-PCC encoder 200 and G-PCC decoder 300 may determine respective spherical coordinate offsets based on the respective spherical coordinate minimum values in the reference frame 2200 and the respective spherical coordinate minimum values in the current frame (2604). The processing circuitry may determine a radius offset (P3[0]) based on a minimum between the first radius minimum value and the second radius minimum value (e.g., P3[0]=min (P1[0], P2[0])). The processing circuitry may determine an azimuth offset (P3[1]) based on a minimum between the first azimuth minimum value and the second azimuth minimum value (e.g., P3[1]=min (P1[1], P2[1])). The processing circuitry may determine a laser identification offset (P3[2]) based on a minimum between the first laser identification minimum value and the second laser identification minimum value (e.g., P3[2]=min (P1[2], P2[2])).

The processing circuitry of G-PCC encoder 200 and G-PCC decoder 300 may apply the respective spherical coordinate offsets to respective spherical coordinates of points in the reference frame (2606). For example, the processing circuitry may subtract the radius offset (P3[0]) from a radius coordinate of a respective point in the reference frame 2200 to generate a radius offset value for the respective point (e.g., P_orig[0]-P3[0], where P_orig[0] is the radius coordinate of a point in reference frame 2200). The processing circuitry may subtract the azimuth offset (P3[1]) from an azimuth coordinate of the respective point in the reference frame 2200 to generate an azimuth offset value for the respective point (e.g., P_orig[1]-P3[1], where P_orig[1] is the azimuth coordinate of a point in reference frame 2200). The processing circuitry may subtract the laser identification offset (P3[2]) from a laser identification coordinate of a respective point in the reference frame 2200 to generate a laser identification offset value for the respective point (e.g., P_orig[2]-P3[2], where P_orig[2] is the laser identification coordinate of a point in reference frame 2200).

The processing circuitry of G-PCC encoder 200 and G-PCC decoder 300 may scale, with respective scale factors, a result of applying the respective spherical coordinate offsets to respective spherical coordinates of points in the reference frame 2200 to generate the updated reference frame 2210 (2608). For example, the processing circuitry may scale, with a first scale factor S[0], the radius offset value for the respective point to generate a radius coordinate for an updated point in the updated reference frame 2210 (e.g., P_updated[0]=(P_orig[0]-P3[0])*S0). The processing circuitry may scale, with a second scale factor S[1], the azimuth offset value for the respective point to generate an azimuth coordinate for the updated point in the updated reference frame 2210 (e.g., P_updated[1]=(P_orig[1]-P3[1])*S1). The processing circuitry may scale, with a third scale factor S[2], the laser identification offset value for the respective point to generate a laser identification coordinate for the updated point in the updated reference frame 2210 (e.g., P_updated[2]=(P_orig[2]-P3[2])*S2).

G-PCC encoder 200 may signal and G-PCC decoder 300 may parse from a bitstream the first scale factor S[0], the second scale factor S[1], and the third scale factor S[2]. However, other ways to determine S[0], S[1], and S[2] are possible. Moreover, S[0], S[1], and S[2] may be the same or may be different. In examples where two or all of S[0], S[1], and S[2] are the same, only one or a subset of the scale factors may be signaled or parsed. Syntax element to indicate that pre-defined default values for S [0], S[1], and S[2] are to be used may be possible.

The above examples describe example techniques for the current frame and generating an updated reference frame for inter-predicting attribute data of the current frame. In some examples, there may be certain constraints that are placed as well. For example, assume that the current frame is a first frame. In some examples, for a second frame, the processing circuitry of G-PCC encoder 200 may signal and the processing circuitry of G-PCC decoder 300 may parse a syntax element, used to determine thresholds, based on a determination that a maximum number of points that can be added per entry in a spherical table used for inter-predicting the second frame is greater than one, wherein the thresholds are used to determine whether a first point is to be added in an entry in the spherical table. For example, G-PCC decoder 300 may parse a syntax element (e.g., dn_sampling_range_plus1), used to determine thresholds (e.g., azimThreshold and radThreshold), based on a determination that a maximum number of points that can be added per entry in a spherical table (e.g., SphTable0) used for inter-predicting the second frame is greater than one (e.g., maxPointsPerEntry>1).

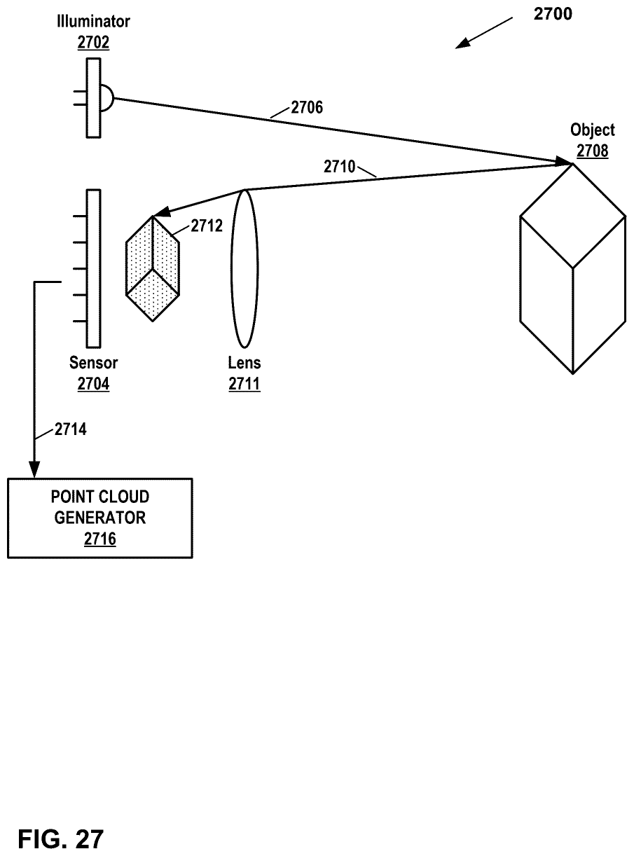

FIG. 27 is a conceptual diagram illustrating an example range-finding system 2700 that may be used with one or more techniques of this disclosure. In the example of FIG. 27, range-finding system 2700 includes an illuminator 2702 and a sensor 2704. Illuminator 2702 may emit light 2706. In some examples, illuminator 2702 may emit light 2706 as one or more laser beams. Light 2706 may be in one or more wavelengths, such as an infrared wavelength or a visible light wavelength. In other examples, light 2706 is not coherent, laser light. When light 2706 encounters an object, such as object 2708, light 2706 creates returning light 2710. Returning light 2710 may include backscattered and/or reflected light. Returning light 2710 may pass through a lens 2711 that directs returning light 2710 to create an image 2712 of object 2708 on sensor 2704. Sensor 2704 generates signals 2714 based on image 2712. Image 2712 may comprise a set of points (e.g., as represented by dots in image 2712 of FIG. 27).

In some examples, illuminator 2702 and sensor 2704 may be mounted on a spinning structure so that illuminator 2702 and sensor 2704 capture a 360-degree view of an environment (e.g., a spinning LIDAR sensor). In other examples, range-finding system 2700 may include one or more optical components (e.g., mirrors, collimators, diffraction gratings, etc.) that enable illuminator 2702 and sensor 2704 to detect ranges of objects within a specific range (e.g., up to 360-degrees). Although the example of FIG. 27 only shows a single illuminator 2702 and sensor 2704, range-finding system 2700 may include multiple sets of illuminators and sensors.

In some examples, illuminator 2702 generates a structured light pattern. In such examples, range-finding system 2700 may include multiple sensors 2704 upon which respective images of the structured light pattern are formed. Range-finding system 2700 may use disparities between the images of the structured light pattern to determine a distance to an object 2708 from which the structured light pattern backscatters. Structured light-based range-finding systems may have a high level of accuracy (e.g., accuracy in the sub-millimeter range), when object 2708 is relatively close to sensor 2704 (e.g., 0.2 meters to 2 meters). This high level of accuracy may be useful in facial recognition applications, such as unlocking mobile devices (e.g., mobile phones, tablet computers, etc.) and for security applications.

In some examples, range-finding system 2700 is a time of flight (ToF)-based system. In some examples where range-finding system 2700 is a ToF-based system, illuminator 2702 generates pulses of light. In other words, illuminator 2702 may modulate the amplitude of emitted light 2706. In such examples, sensor 2704 detects returning light 2710 from the pulses of light 2706 generated by illuminator 2702. Range-finding system 2700 may then determine a distance to object 2708 from which light 2706 backscatters based on a delay between when light 2706 was emitted and detected and the known speed of light in air). In some examples, rather than (or in addition to) modulating the amplitude of the emitted light 2706, illuminator 2702 may modulate the phase of the emitted light 2706. In such examples, sensor 2704 may detect the phase of returning light 2710 from object 2708 and determine distances to points on object 2708 using the speed of light and based on time differences between when illuminator 2702 generated light 2706 at a specific phase and when sensor 2704 detected returning light 2710 at the specific phase.

In other examples, a point cloud may be generated without using illuminator 2702. For instance, in some examples, sensors 2704 of range-finding system 2700 may include two or more optical cameras. In such examples, range-finding system 2700 may use the optical cameras to capture stereo images of the environment, including object 2708. Range-finding system 2700 may include a point cloud generator 2716 that may calculate the disparities between locations in the stereo images. Range-finding system 2700 may then use the disparities to determine distances to the locations shown in the stereo images. From these distances, point cloud generator 2716 may generate a point cloud.

Sensors 2704 may also detect other attributes of object 2708, such as color and reflectance information. In the example of FIG. 27, a point cloud generator 2716 may generate a point cloud based on signals 2714 generated by sensor 2704. Range-finding system 2700 and/or point cloud generator 2716 may form part of data source 104 (FIG. 1). Hence, a point cloud generated by range-finding system 2700 may be encoded and/or decoded according to any of the techniques of this disclosure. Inter prediction and residual prediction, as described in this disclosure may reduce the size of the encoded data.

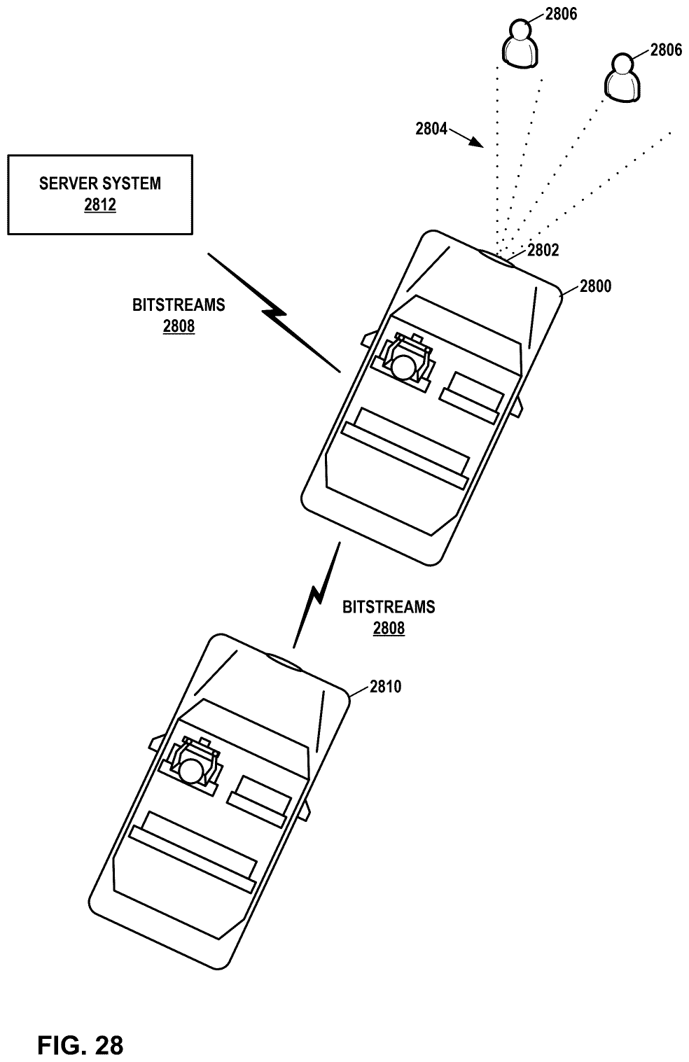

FIG. 28 is a conceptual diagram illustrating an example vehicle-based scenario in which one or more techniques of this disclosure may be used. In the example of FIG. 28, a vehicle 2800 includes a range-finding system 2802. Range-finding system 2802 may be implemented in the manner discussed with respect to FIG. 27. Although not shown in the example of FIG. 28, vehicle 2800 may also include a data source, such as data source 104 (FIG. 1), and a G-PCC encoder, such as G-PCC encoder 200 (FIG. 1). In the example of FIG. 28, range-finding system 2802 emits laser beams 2804 that reflect off pedestrians 2806 or other objects in a roadway. The data source of vehicle 2800 may generate a point cloud based on signals generated by range-finding system 2802. The G-PCC encoder of vehicle 2800 may encode the point cloud to generate bitstreams 2808, such as geometry bitstream (FIG. 2) and attribute bitstream (FIG. 2). Inter prediction and residual prediction, as described in this disclosure may reduce the size of the geometry bitstream. Bitstreams 2808 may include many fewer bits than the unencoded point cloud obtained by the G-PCC encoder.

An output interface of vehicle 2800 (e.g., output interface 108 (FIG. 1) may transmit bitstreams 2808 to one or more other devices. Bitstreams 2808 may include many fewer bits than the unencoded point cloud obtained by the G-PCC encoder. Thus, vehicle 2800 may be able to transmit bitstreams 2808 to other devices more quickly than the unencoded point cloud data. Additionally, bitstreams 2808 may require less data storage capacity on a device.

In the example of FIG. 28, vehicle 2800 may transmit bitstreams 2808 to another vehicle 2810. Vehicle 2810 may include a G-PCC decoder, such as G-PCC decoder 300 (FIG. 1). The G-PCC decoder of vehicle 2810 may decode bitstreams 2808 to reconstruct the point cloud. Vehicle 2810 may use the reconstructed point cloud for various purposes. For instance, vehicle 2810 may determine based on the reconstructed point cloud that pedestrians 2806 are in the roadway ahead of vehicle 2800 and therefore start slowing down, e.g., even before a driver of vehicle 2810 realizes that pedestrians 2806 are in the roadway. Thus, in some examples, vehicle 2810 may perform an autonomous navigation operation based on the reconstructed point cloud.

Additionally, or alternatively, vehicle 2800 may transmit bitstreams 2808 to a server system 2812. Server system 2812 may use bitstreams 2808 for various purposes. For example, server system 2812 may store bitstreams 2808 for subsequent reconstruction of the point clouds. In this example, server system 2812 may use the point clouds along with other data (e.g., vehicle telemetry data generated by vehicle 2800) to train an autonomous driving system. In other example, server system 2812 may store bitstreams 2808 for subsequent reconstruction for forensic crash investigations.

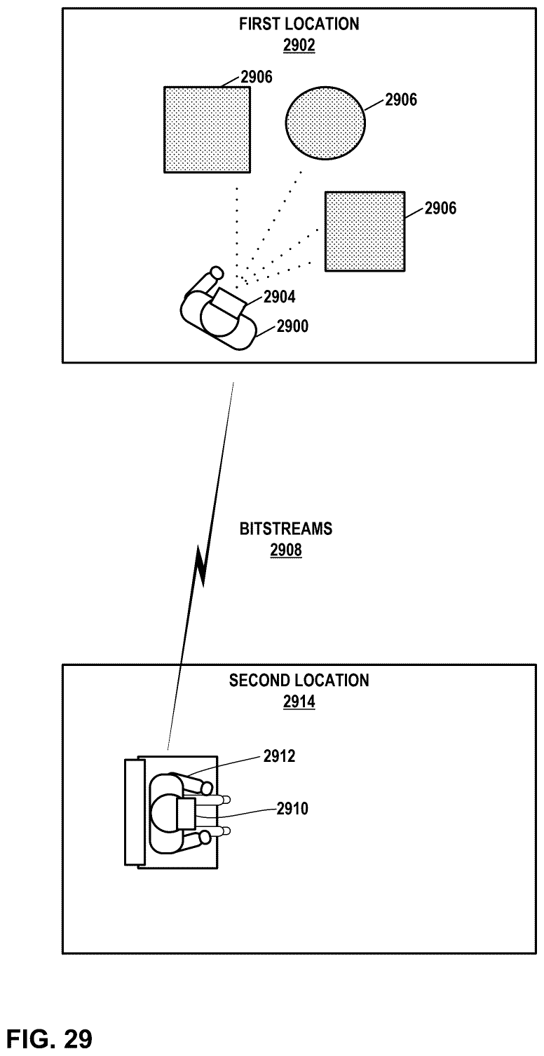

FIG. 29 is a conceptual diagram illustrating an example extended reality system in which one or more techniques of this disclosure may be used. Extended reality (XR) is a term used to cover a range of technologies that includes augmented reality (AR), mixed reality (MR), and virtual reality (VR). In the example of FIG. 29, a user 2900 is located in a first location 2902. User 2900 wears an XR headset 2904. As an alternative to XR headset 2904, user 2900 may use a mobile device (e.g., mobile phone, tablet computer, etc.). XR headset 2904 includes a depth detection sensor, such as a range-finding system, that detects positions of points on objects 2906 at location 2902. A data source of XR headset 2904 may use the signals generated by the depth detection sensor to generate a point cloud representation of objects 2906 at location 2902. XR headset 2904 may include a G-PCC encoder (e.g., G-PCC encoder 200 of FIG. 1) that is configured to encode the point cloud to generate bitstreams 2908. Inter prediction and residual prediction, as described in this disclosure may reduce the size of bitstream 2908.

XR headset 2904 may transmit bitstreams 2908 (e.g., via a network such as the Internet) to an XR headset 2910 worn by a user 2912 at a second location 2914. XR headset 2910 may decode bitstreams 2908 to reconstruct the point cloud. XR headset 2910 may use the point cloud to generate an XR visualization (e.g., an AR, MR, VR visualization) representing objects 2906 at location 2902. Thus, in some examples, such as when XR headset 2910 generates an VR visualization, user 2912 may have a 3D immersive experience of location 2902. In some examples, XR headset 2910 may determine a position of a virtual object based on the reconstructed point cloud. For instance, XR headset 2910 may determine, based on the reconstructed point cloud, that an environment (e.g., location 2902) includes a flat surface and then determine that a virtual object (e.g., a cartoon character) is to be positioned on the flat surface. XR headset 2910 may generate an XR visualization in which the virtual object is at the determined position. For instance, XR headset 2910 may show the cartoon character sitting on the flat surface.

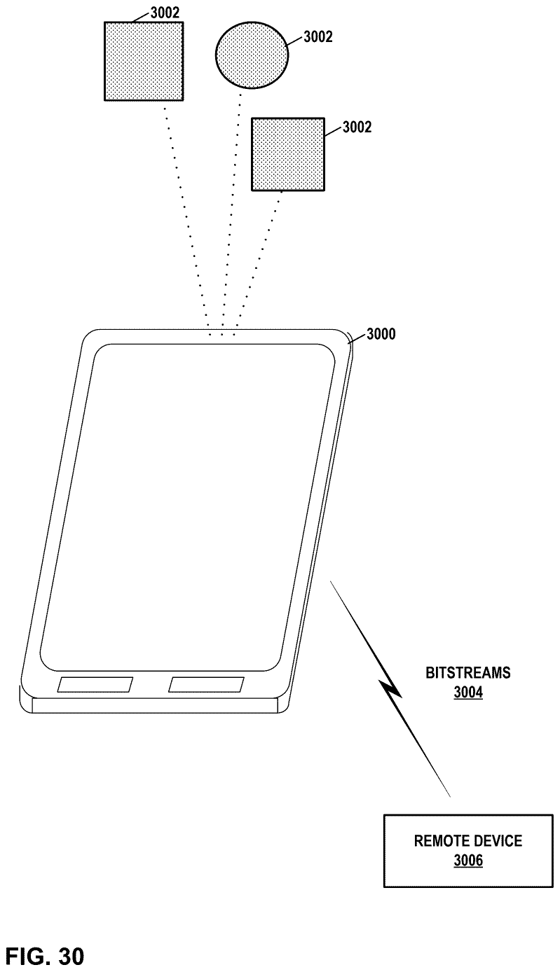

FIG. 30 is a conceptual diagram illustrating an example mobile device system in which one or more techniques of this disclosure may be used. In the example of FIG. 30, a mobile device 3000 (e.g., a wireless communication device), such as a mobile phone or tablet computer, includes a range-finding system, such as a LIDAR system, that detects positions of points on objects 3002 in an environment of mobile device 3000. A data source of mobile device 3000 may use the signals generated by the depth detection sensor to generate a point cloud representation of objects 3002. Mobile device 3000 may include a G-PCC encoder (e.g., G-PCC encoder 200 of FIG. 1) that is configured to encode the point cloud to generate bitstreams 3004. In the example of FIG. 30, mobile device 3000 may transmit bitstreams to a remote device 3006, such as a server system or other mobile device. Inter prediction and residual prediction, as described in this disclosure may reduce the size of bitstreams 3004. Remote device 3006 may decode bitstreams 3004 to reconstruct the point cloud. Remote device 3006 may use the point cloud for various purposes. For example, remote device 3006 may use the point cloud to generate a map of environment of mobile device 3000. For instance, remote device 3006 may generate a map of an interior of a building based on the reconstructed point cloud. In another example, remote device 3006 may generate imagery (e.g., computer graphics) based on the point cloud. For instance, remote device 3006 may use points of the point cloud as vertices of polygons and use color attributes of the points as the basis for shading the polygons. In some examples, remote device 3006 may use the reconstructed point cloud for facial recognition or other security applications.

Examples in the various aspects of this disclosure may be used individually or in any combination.
Clause 1A. A method of coding point cloud data, the method comprising: applying a scale and offset to a reference frame in single stage to generate an updated reference frame; and coding the point cloud data of a current frame based on the updated reference frame.
Clause 2A. A method of coding point cloud data, the method comprising:
coding the point cloud data of a current frame, wherein coding comprises performing offset adjustment for attribute inter prediction for attributes that are coded using predicting transform or lifting transform.
Clause 3A. A method comprising a combination of the methods of clauses 1A and 2A.
Clause 4A. The method of any of clauses 1A-3A, wherein coding comprises inter-prediction coding.
Clause 5A. The method of any of clauses 1A-4A, wherein coding comprises encoding.
Clause 6A. The method of any of clauses 1A-5A, wherein coding comprises decoding.
Clause 7A. The method of any of clauses 1A-6A, further comprising generating the point cloud data.
Clause 8A. A device for coding point cloud data, the device comprising: one or more memories configured to store the point cloud data; and processing circuitry configured to perform the method of any one or more combination of clauses 1A-7A.
Clause 9A. The device of clause 8A, further comprising a display to present imagery based on the point cloud.
Clause 10A. A computer-readable storage medium having stored thereon instructions that, when executed, cause one or more processors to perform the method of any of clauses 1A-7A.
Clause 11A. A device for coding point cloud data, the device comprising means for performing the method of any of clauses 1A-7A.
Clause 1B. A method of decoding point cloud data, the method comprising: applying a scale and offset to a reference frame in a single stage to generate an updated reference frame; and decoding the point cloud data of a current frame based on the updated reference frame.
Clause 2B. The method of clause 1B, wherein applying the scale and offset to the reference frame in the single stage comprises applying the scale and offset to the reference frame without generating an intermediate reference frame that is generated at least in part by subtracting respective spherical coordinate minimum values from respective spherical coordinates of points in the reference frame.
Clause 3B. The method of any of clauses 1B and 2B, wherein applying the scale and offset to the reference frame in the single stage comprises: determining respective spherical coordinate minimum values in the reference frame; determining respective spherical coordinate minimum values in the current frame; determining respective spherical coordinate offsets based on the respective spherical coordinate minimum values in the reference frame and the respective spherical coordinate minimum values in the current frame; applying the respective spherical coordinate offsets to respective spherical coordinates of points in the reference frame; and scaling, with respective scale factors, a result of applying the respective spherical coordinate offsets to respective spherical coordinates of points in the reference frame to generate the updated reference frame.
Clause 4B. The method of clause 3B, wherein spherical coordinates comprise a radius coordinate, an azimuth coordinate, and laser identification coordinate, wherein determining respective spherical coordinate minimum values in the reference frame comprises: determining a first radius minimum value that is a minimum among radius coordinates of the points in the reference frame; determining a first azimuth minimum value that is a minimum among azimuth coordinates of the points in the reference frame; and determining a first laser identification minimum value that is a minimum among laser identification coordinates of the points in the reference frame, wherein determining respective spherical coordinate minimum values in the current frame comprises: determining a second radius minimum value that is a minimum among radius coordinates of points in the current frame; determining a second azimuth minimum value that is a minimum among azimuth coordinates of the points in the current frame; and determining a second laser identification minimum value that is a minimum among laser identification coordinates of the points in the current frame.
Clause 5B. The method of clause 4B, wherein determining respective spherical coordinate offsets based on the respective spherical coordinate minimum values in the reference frame and the respective spherical coordinate minimum values in the current frame comprises: determining a radius offset based on a minimum between the first radius minimum value and the second radius minimum value; determining an azimuth offset based on a minimum between the first azimuth minimum value and the second azimuth minimum value; and determining a laser identification offset based on a minimum between the first laser identification minimum value and the second laser identification minimum value.
Clause 6B. The method of clause 5B, wherein applying the respective spherical coordinate offsets to respective spherical coordinates of points in the reference frame comprises, for each point in the reference frame: subtracting the radius offset from a radius coordinate of a respective point in the reference frame to generate a radius offset value for the respective point; subtracting the azimuth offset from an azimuth coordinate of the respective point in the reference frame to generate an azimuth offset value for the respective point; and subtracting the laser identification offset from a laser identification coordinate of a respective point in the reference frame to generate a laser identification offset value for the respective point; and wherein scaling, with respective scale factors, the result of applying the respective spherical coordinate offsets to the respective spherical coordinates of points in the reference frame to generate the updated reference frame comprises: scaling, with a first scale factor, the radius offset value for the respective point to generate a radius coordinate for an updated point in the updated reference frame; scaling, with a second scale factor, the azimuth offset value for the respective point to generate an azimuth coordinate for the updated point in the updated reference frame; and scaling, with a third scale factor, the laser identification offset value for the respective point to generate a laser identification coordinate for the updated point in the updated reference frame.
Clause 7B. The method of clause 6B, further comprising parsing from a bitstream the first scale factor, the second scale factor, and the third scale factor.
Clause 8B. The method of any of clauses 1B-7B, wherein decoding the point cloud data of the current frame based on the updated reference frame comprises: receiving residual information indicative of a difference between attribute data of points in the current frame and attribute data of points in the updated reference frame; and reconstructing the attribute data of the current frame based on the residual information.
Clause 9B. The method of any of clauses 1B-8B, wherein the current frame is a first frame, the method further comprising: for a second frame, parsing a syntax element, used to determine thresholds, based on a determination that a maximum number of points that can be added per entry in a spherical table used for inter-predicting the second frame is greater than one, wherein the thresholds are used to determine whether a first point is to be added in an entry in the spherical table.
Clause 10B. A device for decoding point cloud data, the device comprising: one or more memories configured to store point cloud data for a current frame and point cloud data for a reference frame; and processing circuitry coupled to the one or more memories and configured to: apply a scale and offset to the reference frame in a single stage to generate an updated reference frame; and decode the point cloud data of the current frame based on the updated reference frame.
Clause 11B. The device of clause 10B, wherein to apply the scale and offset to the reference frame in the single stage, the processing circuitry is configured to apply the scale and offset to the reference frame without generating an intermediate reference frame that is generated at least in part by subtracting respective spherical coordinate minimum values from respective spherical coordinates of points in the reference frame.
Clause 12B. The device of any of clauses 10B and 11B, wherein to apply the scale and offset to the reference frame in the single stage, the processing circuitry is configured to: determine respective spherical coordinate minimum values in the reference frame; determine respective spherical coordinate minimum values in the current frame; determine respective spherical coordinate offsets based on the respective spherical coordinate minimum values in the reference frame and the respective spherical coordinate minimum values in the current frame; apply the respective spherical coordinate offsets to respective spherical coordinates of points in the reference frame; and scale, with respective scale factors, a result of applying the respective spherical coordinate offsets to respective spherical coordinates of points in the reference frame to generate the updated reference frame.
Clause 13B. The device of clause 12B, wherein spherical coordinates comprise a radius coordinate, an azimuth coordinate, and laser identification coordinate, wherein to determine respective spherical coordinate minimum values in the reference frame, the processing circuitry is configured to: determine a first radius minimum value that is a minimum among radius coordinates of the points in the reference frame; determine a first azimuth minimum value that is a minimum among azimuth coordinates of the points in the reference frame; and determine a first laser identification minimum value that is a minimum among laser identification coordinates of the points in the reference frame; wherein to determine respective spherical coordinate minimum values in the current frame, the processing circuitry is configured to: determine a second radius minimum value that is a minimum among radius coordinates of points in the current frame; determine a second azimuth minimum value that is a minimum among azimuth coordinates of the points in the current frame; and determine a second laser identification minimum value that is a minimum among laser identification coordinates of the points in the current frame.
Clause 14B. The device of clause 13B, wherein to determine respective spherical coordinate offsets based on the respective spherical coordinate minimum values in the reference frame and the respective spherical coordinate minimum values in the current frame, the processing circuitry is configured to: determine a radius offset based on a minimum between the first radius minimum value and the second radius minimum value; determine an azimuth offset based on a minimum between the first azimuth minimum value and the second azimuth minimum value; and determine a laser identification offset based on a minimum between the first laser identification minimum value and the second laser identification minimum value.
Clause 15B. The device of clause 14B, wherein to apply the respective spherical coordinate offsets to respective spherical coordinates of points in the reference frame, the processing circuitry is configured to, for each point in the reference frame: subtract the radius offset from a radius coordinate of a respective point in the reference frame to generate a radius offset value for the respective point; subtract the azimuth offset from an azimuth coordinate of the respective point in the reference frame to generate an azimuth offset value for the respective point; and subtract the laser identification offset from a laser identification coordinate of a respective point in the reference frame to generate a laser identification offset value for the respective point; and wherein to scale, with respective scale factors, the result of applying the respective spherical coordinate offsets to the respective spherical coordinates of points in the reference frame to generate the updated reference frame, the processing circuitry is configure to: scale, with a first scale factor, the radius offset value for the respective point to generate a radius coordinate for an updated point in the updated reference frame; scale, with a second scale factor, the azimuth offset value for the respective point to generate an azimuth coordinate for the updated point in the updated reference frame; and scale, with a third scale factor, the laser identification offset value for the respective point to generate a laser identification coordinate for the updated point in the updated reference frame.
Clause 16B. The device of clause 15B, wherein the processing circuitry is configured to parse from a bitstream the first scale factor, the second scale factor, and the third scale factor.
Clause 17B. The device of any of clauses 10B-16B, wherein to decode the point cloud data of the current frame based on the updated reference frame, the processing circuitry is configured to: receive residual information indicative of a difference between attribute data of points in the current frame and attribute data of points in the updated reference frame; and reconstruct the attribute data of the current frame based on the residual information.
Clause 18B. The device of any of clauses 10B-17B, wherein the current frame is a first frame, and wherein the processing circuitry is further configured to: for a second frame, parse a syntax element, used to determine thresholds, based on a determination that a maximum number of points that can be added per entry in a spherical table used for inter-predicting the second frame is greater than one, wherein the thresholds are used to determine whether a first point is to be added in an entry in the spherical table.
Clause 19B. A device for encoding point cloud data, the device comprising: one or more memories configured to store point cloud data for a current frame and point cloud data for a reference frame; and processing circuitry coupled to the one or more memories and configured to: apply a scale and offset to the reference frame in a single stage to generate an updated reference frame; and encode the point cloud data of the current frame based on the updated reference frame.
Clause 20B. The device of clause 19B, wherein to apply the scale and offset to the reference frame in the single stage, the processing circuitry is configured to apply the scale and offset to the reference frame without generating an intermediate reference frame that is generated at least in part by subtracting respective spherical coordinate minimum values from respective spherical coordinates of points in the reference frame.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding point cloud data, the method comprising:
applying a scale and offset to a reference frame in a single stage to generate an updated reference frame; and
decoding the point cloud data of a current frame based on the updated reference frame.

2. The method of claim 1, wherein applying the scale and offset to the reference frame in the single stage comprises applying the scale and offset to the reference frame without generating an intermediate reference frame that is generated at least in part by subtracting respective spherical coordinate minimum values from respective spherical coordinates of points in the reference frame.

3. The method of claim 1, wherein applying the scale and offset to the reference frame in the single stage comprises:
determining respective spherical coordinate minimum values in the reference frame;
determining respective spherical coordinate minimum values in the current frame;
determining respective spherical coordinate offsets based on the respective spherical coordinate minimum values in the reference frame and the respective spherical coordinate minimum values in the current frame;
applying the respective spherical coordinate offsets to respective spherical coordinates of points in the reference frame; and
scaling, with respective scale factors, a result of applying the respective spherical coordinate offsets to respective spherical coordinates of points in the reference frame to generate the updated reference frame.

4. The method of claim 3,
wherein spherical coordinates comprise a radius coordinate, an azimuth coordinate, and laser identification coordinate,
wherein determining respective spherical coordinate minimum values in the reference frame comprises:
determining a first radius minimum value that is a minimum among radius coordinates of the points in the reference frame;
determining a first azimuth minimum value that is a minimum among azimuth coordinates of the points in the reference frame; and
determining a first laser identification minimum value that is a minimum among laser identification coordinates of the points in the reference frame,
wherein determining respective spherical coordinate minimum values in the current frame comprises:
determining a second radius minimum value that is a minimum among radius coordinates of points in the current frame;
determining a second azimuth minimum value that is a minimum among azimuth coordinates of the points in the current frame; and
determining a second laser identification minimum value that is a minimum among laser identification coordinates of the points in the current frame.

5. The method of claim 4,
wherein determining respective spherical coordinate offsets based on the respective spherical coordinate minimum values in the reference frame and the respective spherical coordinate minimum values in the current frame comprises:
determining a radius offset based on a minimum between the first radius minimum value and the second radius minimum value;
determining an azimuth offset based on a minimum between the first azimuth minimum value and the second azimuth minimum value; and
determining a laser identification offset based on a minimum between the first laser identification minimum value and the second laser identification minimum value.

6. The method of claim 5,
wherein applying the respective spherical coordinate offsets to respective spherical coordinates of points in the reference frame comprises, for each point in the reference frame:
subtracting the radius offset from a radius coordinate of a respective point in the reference frame to generate a radius offset value for the respective point;
subtracting the azimuth offset from an azimuth coordinate of the respective point in the reference frame to generate an azimuth offset value for the respective point; and
subtracting the laser identification offset from a laser identification coordinate of a respective point in the reference frame to generate a laser identification offset value for the respective point; and
wherein scaling, with respective scale factors, the result of applying the respective spherical coordinate offsets to the respective spherical coordinates of points in the reference frame to generate the updated reference frame comprises:
scaling, with a first scale factor, the radius offset value for the respective point to generate a radius coordinate for an updated point in the updated reference frame;
scaling, with a second scale factor, the azimuth offset value for the respective point to generate an azimuth coordinate for the updated point in the updated reference frame; and
scaling, with a third scale factor, the laser identification offset value for the respective point to generate a laser identification coordinate for the updated point in the updated reference frame.

7. The method of claim 6, further comprising parsing from a bitstream the first scale factor, the second scale factor, and the third scale factor.

8. The method of claim 1, wherein decoding the point cloud data of the current frame based on the updated reference frame comprises:
receiving residual information indicative of a difference between attribute data of points in the current frame and attribute data of points in the updated reference frame; and
reconstructing the attribute data of the current frame based on the residual information.

9. The method of claim 1, wherein the current frame is a first frame, the method further comprising:
for a second frame, parsing a syntax element, used to determine thresholds, based on a determination that a maximum number of points that can be added per entry in a spherical table used for inter-predicting the second frame is greater than one, wherein the thresholds are used to determine whether a first point is to be added in an entry in the spherical table.

10. A device for decoding point cloud data, the device comprising:
one or more memories configured to store point cloud data for a current frame and point cloud data for a reference frame; and
processing circuitry coupled to the one or more memories and configured to:
apply a scale and offset to the reference frame in a single stage to generate an updated reference frame; and
decode the point cloud data of the current frame based on the updated reference frame.

11. The device of claim 10, wherein to apply the scale and offset to the reference frame in the single stage, the processing circuitry is configured to apply the scale and offset to the reference frame without generating an intermediate reference frame that is generated at least in part by subtracting respective spherical coordinate minimum values from respective spherical coordinates of points in the reference frame.

12. The device of claim 10, wherein to apply the scale and offset to the reference frame in the single stage, the processing circuitry is configured to:
determine respective spherical coordinate minimum values in the reference frame;
determine respective spherical coordinate minimum values in the current frame;
determine respective spherical coordinate offsets based on the respective spherical coordinate minimum values in the reference frame and the respective spherical coordinate minimum values in the current frame;
apply the respective spherical coordinate offsets to respective spherical coordinates of points in the reference frame; and
scale, with respective scale factors, a result of applying the respective spherical coordinate offsets to respective spherical coordinates of points in the reference frame to generate the updated reference frame.

13. The device of claim 12,
wherein spherical coordinates comprise a radius coordinate, an azimuth coordinate, and laser identification coordinate,
wherein to determine respective spherical coordinate minimum values in the reference frame, the processing circuitry is configured to:
determine a first radius minimum value that is a minimum among radius coordinates of the points in the reference frame;
determine a first azimuth minimum value that is a minimum among azimuth coordinates of the points in the reference frame; and
determine a first laser identification minimum value that is a minimum among laser identification coordinates of the points in the reference frame,
wherein to determine respective spherical coordinate minimum values in the current frame, the processing circuitry is configured to:
determine a second radius minimum value that is a minimum among radius coordinates of points in the current frame;
determine a second azimuth minimum value that is a minimum among azimuth coordinates of the points in the current frame; and
determine a second laser identification minimum value that is a minimum among laser identification coordinates of the points in the current frame.

14. The device of claim 13,
wherein to determine respective spherical coordinate offsets based on the respective spherical coordinate minimum values in the reference frame and the respective spherical coordinate minimum values in the current frame, the processing circuitry is configured to:
determine a radius offset based on a minimum between the first radius minimum value and the second radius minimum value;
determine an azimuth offset based on a minimum between the first azimuth minimum value and the second azimuth minimum value; and
determine a laser identification offset based on a minimum between the first laser identification minimum value and the second laser identification minimum value.

15. The device of claim 14,
wherein to apply the respective spherical coordinate offsets to respective spherical coordinates of points in the reference frame, the processing circuitry is configured to, for each point in the reference frame:
subtract the radius offset from a radius coordinate of a respective point in the reference frame to generate a radius offset value for the respective point;
subtract the azimuth offset from an azimuth coordinate of the respective point in the reference frame to generate an azimuth offset value for the respective point; and
subtract the laser identification offset from a laser identification coordinate of a respective point in the reference frame to generate a laser identification offset value for the respective point; and
wherein to scale, with respective scale factors, the result of applying the respective spherical coordinate offsets to the respective spherical coordinates of points in the reference frame to generate the updated reference frame, the processing circuitry is configure to:
scale, with a first scale factor, the radius offset value for the respective point to generate a radius coordinate for an updated point in the updated reference frame;
scale, with a second scale factor, the azimuth offset value for the respective point to generate an azimuth coordinate for the updated point in the updated reference frame; and
scale, with a third scale factor, the laser identification offset value for the respective point to generate a laser identification coordinate for the updated point in the updated reference frame.

16. The device of claim 15, wherein the processing circuitry is configured to parse from a bitstream the first scale factor, the second scale factor, and the third scale factor.

17. The device of claim 10, wherein to decode the point cloud data of the current frame based on the updated reference frame, the processing circuitry is configured to:
receive residual information indicative of a difference between attribute data of points in the current frame and attribute data of points in the updated reference frame; and
reconstruct the attribute data of the current frame based on the residual information.

18. The device of claim 10, wherein the current frame is a first frame, and wherein the processing circuitry is further configured to:
for a second frame, parse a syntax element, used to determine thresholds, based on a determination that a maximum number of points that can be added per entry in a spherical table used for inter-predicting the second frame is greater than one, wherein the thresholds are used to determine whether a first point is to be added in an entry in the spherical table.

19. A device for encoding point cloud data, the device comprising:
one or more memories configured to store point cloud data for a current frame and point cloud data for a reference frame; and
processing circuitry coupled to the one or more memories and configured to:
apply a scale and offset to the reference frame in a single stage to generate an updated reference frame; and
encode the point cloud data of the current frame based on the updated reference frame.

20. The device of claim 19, wherein to apply the scale and offset to the reference frame in the single stage, the processing circuitry is configured to apply the scale and offset to the reference frame without generating an intermediate reference frame that is generated at least in part by subtracting respective spherical coordinate minimum values from respective spherical coordinates of points in the reference frame.
